(19) United States
(12) Patent Application Publication
(10) Pub. No.: US 2024/0275294 A1
(43) Pub. Date: Aug. 15, 2024

(54) MAGNETIC APPARATUS WITH SYMMETRIC QUADRUPLE OR OCTUPLE WINDING ARRANGEMENT, POWER MODULE, POWER CONVERSION DEVICE, AND DC-DC CONVERSION DEVICE

(71) Applicant: SHANGHAI METAPWR ELECTRONICS CO., LTD, Shanghai (CN)

(72) Inventor: Jianhong ZENG, Shanghai (CN)

(73) Assignee: SHANGHAI METAPWR ELECTRONICS CO., LTD, Shanghai (CN)

(21) Appl. No.: 18/433,216

(22) Filed: Feb. 5, 2024

(30) Foreign Application Priority Data
Feb. 10, 2023 (CN) 202310099821.4

(51) Int. Cl. H02M 3/335; H01F 27/26; H01F 27/30; H02M 3/00

(52) U.S. Cl. CPC H02M 3/33576; H01F 27/26; H01F 27/306; H02M 3/01

(57) ABSTRACT

A magnetic apparatus with symmetric quadruple or octuple winding arrangement is provided. The magnetic apparatus includes a winding substrate provided with pairs of windings and a multiple-leg magnetically permeable core assembled on the winding substrate. Current self-equalization results from control signals with progressive phase offsets between groups and a phase offset of 180 degrees within groups. A power module including the winding substrate, the windings, a high-voltage circuits including bridge arms of switches and resonance branches, and low-voltage circuits including synchronous rectifiers, and with a DC input are used to form a DC-DC conversion device. Multiple circuit topology is provided and implemented in the structures of the power module and the DC-DC conversion device.

### CROSS-REFERENCE TO RELATED APPLICATION

This application claims the priority benefit of China application serial no. 202310099821.4 filed on Feb. 10, 2023. The entirety of the above-mentioned patent application is hereby incorporated by reference herein and made a part of this specification.

### BACKGROUND

### Technical Field

The invention relates to a field of power conversion, in particular to a magnetic apparatus, a power module, a power conversion device, and a dc-dc conversion device.

### Description of Related Art

With the development of artificial intelligence, the power requirements of artificial intelligence data processing chips, such as CPUs, GPUs, TPUs and the like (collectively referred to as XPUs) are higher and higher, so that the power supply of the server is greatly increased, the power supply voltage of the system board rises from 12V to 48V. Two-stage voltage reduction circuits gradually become mainstream when the power supply voltage of the system board is 48V.

The intermediate conversion device in the two-stage voltage reduction circuit is a conversion device for the voltage conversion between the input bus and the output bus, and the ratio of the input voltage to the output voltage is either a fixed gain ratio or an unfixed gain ratio. Fixed gain ratio is usually 4:1, 8:1 or 12:1, etc. The intermediate conversion device with a fixed gain ratio is usually in an LLC circuit topology, and the LLC circuit topology provides zero-voltage turn-on (i.e., zero-voltage switching, ZVS) or zero-current turn-on (i.e., zero-current switching, ZCS) of the switch connected with the transformer according to the switching frequency, and shows beneficial effects of high switching frequency, high power conversion efficiency, and high power density.

### SUMMARY

With the output voltage of the intermediate conversion device lower and lower and the fixed gain ratio larger and larger, the number of low-voltage winding turns of the transformer in the LLC circuit topology is reduced from multiple turns to one turn or even reduced to 0.5 turn. Mainly aiming at the LLC circuit topology with transformer low-voltage windings of 0.5 or 1 turn, the present application discloses magnetic apparatus structures, winding arrangements and circuit element layouts in power modules and power conversion devices in various embodiments, which are suitable for industrial standard implementations and show beneficial effects of low transformer power loss, low total power loss, high efficiency and small size.

In general, one aspect features an apparatus comprising:
a magnetically permeable core and at least two winding groups;
wherein the magnetically permeable core comprises two core plates and five core legs, the five core legs are arranged between the two core plates, the five core legs are respectively a first side core leg, a first winding core leg, a public core leg, a second winding core leg and a second side core leg, and are arranged in the same direction according to the sequence of the first side core leg, the first winding core leg, the public core leg, the second winding core leg and the second side core leg, and a channel between every two adjacent core legs is configured as a winding channel;
wherein the magnetically permeable core are provided with an input side and an output side which are opposite to each other, and the magnetically permeable core are provided with a first winding channel side and a second winding channel side which are opposite to each other; each core plate is provided with four side surfaces corresponding to the input side, the output side, the first winding channel side and the second winding channel side; and the winding channel is configured to penetrate the magnetically permeable core from the first winding channel side to the second winding channel side;
wherein the two winding groups are respectively a first winding group and a third winding group, the first winding group sequentially passes through the two winding channels adjacent to the first winding core leg, and is wound around the first winding core leg for at least one turn; the third winding group sequentially passes through the two winding channels adjacent to the second winding core leg, and is wound around the second winding core leg for at least one turn; and
wherein it is provided in operation that voltage signal across the first winding group and voltage signal across the second winding group have a phase offset of 90 degrees.

Implementations of the apparatus may include one or more of following features. The voltage signals across each of the two winding groups are configured to have same shape in waveform.

Implementations of the apparatus may include one or more of following features. The first winding core leg and the second winding core leg are provided with same reluctances; and
the first side core leg, the second side core leg and the public core leg are provided with same reluctances.

Implementations of the apparatus may include one or more of following features. The reluctance of the first side core leg, the reluctance of the second side core leg and the reluctance of the public core leg are smaller than or equal to the reluctance of the first winding core leg and the second winding core leg.

Implementations of the apparatus may include one or more of following features. The reluctance of the first side core leg, the reluctance of the second side core leg and the reluctance of the public core leg is smaller than 1/10 of the reluctance of the first winding core leg and the second winding core leg.

Implementations of the apparatus may include one or more of following features. Each winding group comprises two windings; the winding is provided with a first end and a second end; the second end of each winding is electrically connected with each other; the first end of each winding is electrically connected with a switch; the first end of each winding in the first and third winding groups is located on the first winding channel side, and each switch corresponding to the first and third winding groups is arranged close to the first winding channel side.

Implementations of the apparatus may include one or more of following features. Each winding group is wound around the corresponding winding core leg for an odd number of turns, the second end of each winding is located on the second winding channel side, the second end of each winding is electrically connected to at least one output capacitor, and each output capacitor is arranged close to the second winding channel side.

Implementations of the apparatus may include one or more of following features. Each winding group is wound around the winding core leg for an even number of turns, the first end and the second end of each winding are located on the same winding channel side, the second end of each winding is electrically connected with at least one output capacitor, and each output capacitor is arranged close to the first winding channel side.

Implementations of the apparatus may include one or more of following features. Voltage signals across each of the two windings in the same winding group are configured to have a phase offset of 180 degrees, and the voltage signals across each of the four windings are configured to have offsets of 90 degrees progressively in sequence.

Implementations of the apparatus may include one or more of following features. The apparatus further comprises a second winding group and a fourth winding group. The second winding group sequentially passes through two winding channels adjacent to the first winding core leg, and is wound around the first winding core leg for at least one turn; the fourth winding group sequentially passes through the two winding channels adjacent to the second winding core leg, and is wound around the second winding core leg for at least one turn; each of the second and fourth winding groups comprises two windings; the second ends of the two windings in the same winding group are electrically connected with each other; the first ends of the two windings are electrically connected with a switch; the first end of each winding in the second and fourth winding groups is located on the second winding channel side; and each switch corresponding to the second and fourth winding groups is arranged close to the second winding channel side.

Implementations of the apparatus may include one or more of following features. The first end of one winding in the first winding group and the first end of one winding in the second winding group are located in different winding channels, and voltage signals at the two first ends are configured to be same in waveform; the first end of one winding in the third winding group and the first end of one winding in the fourth winding group are located in different winding channels, and voltage signals at the two first ends are configured to be same in waveform; and
the windings in each winding group are low-voltage windings, the magnetic apparatus further comprises two high-voltage windings, and one said high-voltage winding sequentially passes through two winding channels adjacent to the first winding core leg and is wound around the first winding core leg; and the other high-voltage winding sequentially passes through the two winding channels adjacent to the second winding core leg and is wound around the second winding core leg.

Implementations of the apparatus may include one or more of following features. The windings in each winding group are low-voltage windings, the magnetic apparatus further comprises two high-voltage windings, and one said high-voltage winding sequentially passes through two winding channels adjacent to the first winding core leg and is wound around the first winding core leg; and the other high-voltage winding sequentially passes through the two winding channels adjacent to the second winding core leg and is wound around the second winding core leg.

Implementations of the apparatus may include one or more of following features. The apparatus further comprises a first additional winding wound around one side core leg and the winding core leg next to the side core leg as a whole, or further comprises a first additional winding wound around a part of the core plate between the winding core leg and the public core leg; the first additional winding is electrically connected in parallel with one winding corresponding to the winding core leg corresponding thereto; and
the first additional winding is configured for adjusting the AC magnetic flux flowing through the corresponding side core leg to be opposite in direction and half in amplitude compared with the AC magnetic flux flowing through the corresponding winding core leg.

Implementations of the apparatus may include one or more of following features. The apparatus further comprises another first additional winding wound around the other side core leg and the other winding core leg as a whole, or further comprises another first additional winding wound around a part of the core plate between the other winding core leg and the public core leg.

Implementations of the apparatus may include one or more of following features. The apparatus further comprises a second additional winding; the second additional winding is wound around the public core leg, two ends of the second additional winding are respectively electrically connected to the first winding group and the second winding group, and the second additional winding is configured for adjusting the AC magnetic flux flowing through the public core leg to be half in amplitude of the superposition of the AC magnetic flux flowing through the two winding core legs.

In general, another aspect features a power module, comprising:
a winding substrate, a magnetically permeable core and output pins;
wherein the winding substrate is provided with a first surface and a second surface opposite to each other,
wherein the magnetically permeable core comprises two core plates and three core legs, the three core legs are arranged between the two core plates, the three core legs are a first side core leg, a winding core leg and a second side core leg respectively, the winding core leg is arranged between the first side core leg and the second side core leg, and a winding channel is provided between each side core leg and the winding core leg;
wherein the magnetically permeable core is provided with an input side and an output side which are opposite to each other, and the magnetically permeable core is provided with a first winding channel side and a second winding channel side which are opposite to each other; each core plate is provided with four side surfaces corresponding to the input side, the output side, the first winding channel side and the second winding channel side; and the winding channel is configured to penetrate the magnetically permeable core from the first winding channel side to the second winding channel side;
wherein the output pins are arranged close to the output side and at least three output pins are provided, at least one of the output pins is configured in a first electrical property and at least one of the output pins is configured in a second electrical property, and the output pins are alternately arranged according to the electrical properties;
wherein the winding substrate is provided with three magnetically-permeable-core holes, and the three magnetically-permeable-core holes match the three core legs in shape; two winding groups is provided in the winding substrate; the two winding groups are a first winding group and a second winding group respectively, and each winding group sequentially passes through the two winding channels and is wound around the winding core leg; and
wherein each winding group comprises two windings, the winding is provided with a first end and a second end, the second ends of the two windings in the same winding group are electrically connected with each other and with at least one of the output pins, and the first ends of the two windings in the first winding group and the first ends of the two windings in the second winding group are arranged opposite on the first winding channel side and the second winding channel side respectively.

Implementations of the power module may include one or more of following features. The output pins are arranged in an array along the side surface corresponding to the output side.

Implementations of the power module may include one or more of following features. Each winding group is wound around the corresponding winding core leg for an odd number of turns, and the second end and the first end of each winding in each winding group are respectively arranged on the first winding channel side and the second winding channel side.

Implementations of the power module may include one or more of following features. Each winding group is wound around the corresponding winding core leg for an even number of turns, and the second end and the first end of each winding in each winding group are arranged on the same winding channel side.

Implementations of the power module may include one or more of following features. The power module further comprises at least one first switching circuit and at least one second switching circuit, wherein the first switching circuit and the second switching circuit are respectively arranged on the first winding channel side and the second winding channel side and close to openings of the winding channels; each of the first and second switching groups comprises two switches; one ends of the two switches in the same switching circuit are electrically connected with the first ends of the two windings in the same winding group respectively, the other ends of the two switches are electrically connected with each other and are electrically connected with the output negative pins, and the second ends of the windings are electrically connected with the output positive pins.

Implementations of the power module may include one or more of following features. Control signals are provided for the switches; the control signals of the two switches in the same switching circuit are in a phase offset of 180 degrees, one switch in the first switching circuit and one switch in the second switching circuit are arranged close to different winding channels, and the control signals of the two switches are same.

Implementations of the power module may include one or more of following features. Two first switching circuits and two second switching circuits are provided; the two first switching circuits are arranged on the first surface and the second surface of the winding substrate respectively; the two first switching circuits partially overlap or wholly coincide with each other in projection to the first surface, and the two first switching circuits are electrically connected in parallel by vias through the winding substrate; the two second switching circuits are arranged on the first surface and the second surface of the winding substrate respectively; the two second switching circuits partially overlap or wholly coincide with each other in projection to the first surface, and the two second switching circuits are electrically connected in parallel by vias through the winding substrate.

Implementations of the power module may include one or more of following features. The power module further comprises at least one output capacitor, wherein the output capacitor is bridged between the second end of the winding and the corresponding other end of the switch connected with the first end of the winding.

Implementations of the power module may include one or more of following features. At least one output capacitor is arranged on the outer side of the magnetically permeable core on the first winding channel side, and at least one output capacitor is arranged on the outer side of the magnetically permeable core on the second winding channel side.

Implementations of the power module may include one or more of following features. At least one output capacitor is arranged on the outer side of the first switching circuit, and at least one output capacitor is arranged on the outer side of the second switching circuit.

Implementations of the power module may include one or more of following features. The power module further comprises a high-voltage winding, wherein the windings in the winding groups are low-voltage windings, and the high-voltage winding sequentially passes through the two winding channels and is wound around the winding core leg for at least one turn; and two ends of the high-voltage winding are arranged on the same winding channel side.

Implementations of the power module may include one or more of following features. Included angle between the arrangement direction of the array and the side surface is less than or equal to 45 degrees.

In general, another aspect features an power conversion device, comprising:
a winding substrate, a magnetic apparatus, a first switching circuit, a second switching circuit, a first output capacitor group, a second output capacitor group, a first output pin group and a second output pin group;
wherein the winding substrate is provided with a first surface and a second surface which are opposite to each other; the second surface is provided with a first output region, a first switch region, a magnetic assembly region, a second switch region and a second output region; the first output region, the first switch region, the magnetic assembly region, the second switch region and the second output region are sequentially arranged in the same direction; and
wherein the magnetic apparatus is assembled in the magnetic assembly region; the first switching circuit is arranged in the first switch region; the second switching circuit is arranged in the second switch region; at least one part of the first output capacitor group and/or at least one part of the first output pin group is arranged in the first output region; at least one part of the second output capacitor group and/or at least one part of the second output pin group is arranged in the second output region.

Implementations of the power conversion device may include one or more of following features. The first output capacitor group, the first switching circuit, the magnetic apparatus, the second switching circuit and the second output capacitor group are sequentially arranged in the same direction.

Implementations of the power conversion device may include one or more of following features. The first output pin group, the first switching circuit, the magnetic apparatus, the second switching circuit and the second output pin group are sequentially arranged in the same direction.

Implementations of the power conversion device may include one or more of following features. The first output pin group, the first output capacitor group, the first switching circuit, the magnetic apparatus, the second switching circuit, the second output capacitor group and the second output pin group are sequentially arranged in the same direction.

Implementations of the power conversion device may include one or more of following features. The magnetic apparatus comprises a magnetically permeable core; the magnetically permeable core comprises two core plates and at least three core legs; the core legs are arranged between the two core plates; the core legs comprise a first side core leg, a second side core leg and at least one winding core leg; the winding core leg is arranged between the first side core leg and the second side core leg, and winding channels are provided between the winding core leg and the adjacent core legs; the magnetically permeable core is provided with a first winding channel side and a second winding channel side which are opposite to each other; the winding channel is configured to penetrate the magnetic permeable core from the first winding channel side to the second winding channel side.

Implementations of the power conversion device may include one or more of following features. The winding substrate is provided with at least three magnetically-permeable-core holes; the magnetically-permeable-core holes match the at least three core legs in number and shape; two winding groups are provided in the winding substrate; the two winding groups are a first winding group and a second winding group respectively, and each winding group sequentially passes through two winding channels adjacent to the winding core leg and is wound around the corresponding winding core leg; each winding group comprises two windings; each winding is provided with a first end and a second end; the second ends of the two windings in the same winding group are electrically connected; the first ends of the two windings in the first winding group and the first ends of the two windings in the second winding group are arranged on the first winding channel side and the second winding channel side respectively; and
the first switch region is located on the first winding channel side, and the second switch region is located on the second switch region.

In general, another aspect features a DC-DC conversion device, comprising:
high-voltage terminals and low-voltage terminals, wherein the DC-DC conversion device is used for voltage transformation between the high-voltage terminal and the low-voltage terminal, and the ratio of voltage at the high-voltage terminal to voltage at the low-voltage terminal is K;
at least one high-voltage capacitor, at least one low-voltage capacitor and N circuit units, wherein N is an integer greater than or equal to 2, and each circuit unit comprises a high-voltage circuit and a low-voltage circuit;
wherein the circuit unit further comprises a transformer; the transformer is electrically connected with the low-voltage circuit and is electrically connected to at least one low-voltage capacitor;
wherein the high-voltage circuit comprises two bridge arms; the two bridge arms are respectively a first bridge arm and a second bridge arm; the first bridge arm comprises an upper switch and a lower switch which are electrically connected in series; at least one part of the transformer is configured for forming at least one resonance branch; one end of the resonance branch is electrically connected with the first bridge arm, and the other end of the resonance branch is electrically connected with the second bridge arm;
wherein the DC-DC conversion device is provided with N control signal groups, the N control signal groups respectively control the switches in the N circuit units, each control signal group comprises a first control signal; the duty ratio of the first control signal in each control signal group is same, and first control signals in the N control signal groups are configured to have a phase offset of 360/(2N) degrees progressively in sequence;
wherein resonant capacitors are provided in the high-voltage circuits; equivalent total capacitance of the low-voltage capacitors in a steady state operation is less than or equal to N×K×K times the equivalent total capacitance of the resonant capacitors.

Implementations of the DC-DC conversion device may include one or more of following features. The equivalent total capacitance of the low-voltage capacitor in a steady state operation is less than or equal to 0.5×N×K×K times the equivalent total capacitance of the resonant capacitors.

Implementations of the DC-DC conversion device may include one or more of following features. The equivalent total capacitance of the low-voltage capacitor in a steady state operation is less than or equal to 0.25×N×K×K times the equivalent total capacitance of the resonant capacitors.

Implementations of the DC-DC conversion device may include one or more of following features. The equivalent total capacitance of the high-voltage capacitor in a steady state operation is less than or equal to N times the equivalent total capacitance of the resonant capacitors.

Implementations of the DC-DC conversion device may include one or more of following features. The equivalent total capacitance of the high-voltage capacitor in a steady state operation is less than or equal to 0.25×N times the equivalent total capacitance of the resonant capacitors.

Implementations of the DC-DC conversion device may include one or more of following features. Each high-voltage circuit in the N circuit units is connected in parallel and then bridged between two ends of the at least one high-voltage capacitor, and each low-voltage circuit in the N circuit units is connected in parallel and then bridged between the two ends of the at least one low-voltage capacitor; and
negative terminal of the at least one high-voltage capacitor is electrically connected with negative terminal of the at least one low-voltage capacitor, or negative terminal of the at least one high-voltage capacitor is electrically isolated from negative terminal of the at least one low-voltage capacitor.

Implementations of the DC-DC conversion device may include one or more of following features. The low-voltage circuits are electrically connected in parallel; each of the low-voltage circuits is bridged between two ends of at least one low-voltage capacitor; the high-voltage circuits are electrically connected in parallel; one end of each of the high-voltage circuits is electrically connected with a positive terminal of at least one high-voltage capacitor; the other end of each of the high-voltage circuits is electrically connected with a negative terminal of at least one low-voltage capacitor; and a negative terminal of at least one high-voltage capacitor is electrically connected with a positive terminal of at least one low-voltage capacitor.

Implementations of the DC-DC conversion device may include one or more of following features. The transformer comprises at least one winding group; each winding group comprises two low-voltage windings; second ends of the two low-voltage windings are electrically connected with each other and with at least one output capacitor; first ends of the two low-voltage windings are electrically connected with the low-voltage circuit respectively.

Implementations of the DC-DC conversion device may include one or more of following features. The transformer comprises at least one high-voltage winding;
at least one additional inductor is provided in the high-voltage circuit for an equivalent resonant inductor, or leakage inductance of the at least one high-voltage winding forms an equivalent resonant inductor; and
the resonant capacitor, the equivalent resonant inductor and the high-voltage winding are electrically connected in series in the resonance branch.

Implementations of the DC-DC conversion device may include one or more of following features. The second bridge arm comprises an upper switch and a lower switch which are electrically connected in series; ends of the two bridge arms corresponding to the upper switch are electrically connected; the two ends of the resonance branch are electrically connected with middle nodes of the two bridge arms respectively; each control signal group further comprises a second control signal; the first control signal and the second control signal are configured to have a phase offset of 180 degrees; the upper switch of the first bridge arm and the lower switch of the second bridge arm are controlled by the first control signal, and the lower switch of the first bridge arm and the upper switch of the second bridge arm are controlled by the second control signal.

Implementations of the DC-DC conversion device may include one or more of following features. The transformer comprises at least one high-voltage winding;
at least one additional inductor is provided for an equivalent resonant inductor, or leakage inductance of the at least one high-voltage winding forms an equivalent resonant inductor;
the equivalent resonant inductor and the part of the transformer are electrically connected in series in the resonance branch; and
the resonant capacitors are configured as the second bridge arm; each second bridge arm comprises two resonant capacitors which are electrically connected in series, the first bridge arm is electrically connected with the second bridge arm in parallel; the two ends of the resonance branch are electrically connected with middle nodes of the first bridge arm and the second bridge arm respectively.

Implementations of the DC-DC conversion device may include one or more of following features. The high-voltage circuit is connected in parallel with at least one high-voltage capacitor.

Implementations of the DC-DC conversion device may include one or more of following features. One end of the high-voltage circuit is electrically connected with a positive terminal of the at least one high-voltage capacitor; the other end of the high-voltage circuit is electrically connected with a negative terminal of the at least one low-voltage capacitor; a negative terminal of the at least one high-voltage capacitor is electrically connected with a positive terminal or the negative terminal of the at least one low-voltage capacitor.

Implementations of the DC-DC conversion device may include one or more of following features. The second bridge arm comprises an upper switch and a lower switch which are electrically connected in series, and ends of the two bridge arms corresponding to the upper switch are electrically connected; the low-voltage circuit comprises two low-voltage switches, one ends of the two low-voltage switches are electrically connected, and the other ends of the two low-voltage switches are electrically connected with the other ends of the two bridge arms respectively; each control signal group further comprises a second control signal, and the first control signal and the second control signal are configured to have a phase offset of 180 degrees;
the first control signal controls the upper switch of the first bridge arm, the lower switch of the second bridge arm and the low-voltage switch corresponding to the first bridge arm; and
the second control signal controls the upper switch of the second bridge arm, the lower switch of the first bridge arm and the low-voltage switch corresponding to the second bridge arm.

Implementations of the DC-DC conversion device may include one or more of following features. The resonance branch is bridged between the middle nodes of the two bridge arms.

Implementations of the DC-DC conversion device may include one or more of following features. Two high-voltage windings are provided, and two resonance branch are provided corresponding to the two bridge arms; and
one end of each resonance branch is electrically connected with middle node of one corresponding bridge arm, and the other end of each resonance branch is electrically connected with the electrical connection node of the other bridge arm and the low-voltage circuit.

Implementations of the DC-DC conversion device may include one or more of following features. The second bridge arm comprises an upper switch and a lower switch which are electrically connected in series, one ends of the two bridge arms are electrically connected; the low-voltage circuit comprises two low-voltage switches; one ends of the two low-voltage switches are electrically connected; the other ends of the two low-voltage switches are electrically connected with the other ends of the two switch bridge arms respectively; each control signal group further comprises a second control signal, and the first control signal and the second control signal are configured to have a phase offset of 180 degrees;
the first control signal controls an upper switch of one bridge arm, a low-voltage switch electrically connected with the corresponding bridge arm and a lower switch of the other bridge arm; and the second control signal controls a lower switch of the corresponding bridge arm, an upper switch of the other bridge arm and a low-voltage switch electrically connected with the other bridge arm; and
at least two equivalent resonant inductors are provided, the two equivalent resonant inductors are respectively electrically connected with a resonant capacitor for forming two resonance branches corresponding to the two bridge arms; one end of each resonance branch is electrically connected with the middle node of one corresponding bridge arm, and the other end of each resonant branch is electrically connected with electrical connection node of the other bridge arm and the low-voltage circuit.

Implementations of the DC-DC conversion device may include one or more of following features. Two resonant capacitors are provided for forming the second bridge arm; the two resonant capacitors are electrically connected in series in the second bridge arm; the second bridge arm is electrically connected with the first bridge arm in parallel; the transformer comprises at least one high-voltage winding and at least two low-voltage windings; at least one equivalent resonant inductor is provided; the at least one high-voltage winding is electrically connected with the equivalent resonant inductor for forming a resonance branch; one end of the resonance branch is electrically connected with a middle node of the first bridge arm, and the other end of the resonance branch is electrically connected with a middle node of the second bridge arm; second ends of the two low-voltage windings are electrically connected with each other and with the at least one output capacitor; first ends of the two low-voltage windings are electrically connected with the low-voltage circuit respectively.

Implementations of the DC-DC conversion device may include one or more of following features. The transformer comprises the apparatus as described above in the first aspect.

The details of one or more embodiments of the application are set forth in the accompanying drawings and description below. Other features, objects, and advantages of the application will be apparent from the description and drawings, and from the claims.

### BRIEF DESCRIPTION OF THE DRAWINGS

FIG. 1A to FIG. 3C are schematic diagrams of Embodiment 1.

FIG. 4A to FIG. 6D are schematic diagrams of Embodiment 2.

FIG. 7A to FIG. 7C are schematic diagrams of Embodiment 3.

FIG. 8A is a schematic diagram of Embodiment 4.

FIG. 8B is a schematic diagram of Embodiment 5.

FIG. 8C is a schematic diagram of Embodiment 6.

FIG. 8D is a schematic diagram of Embodiment 7.

FIG. 9A to FIG. 9D are schematic diagrams of Embodiment 8.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

### Embodiment 1

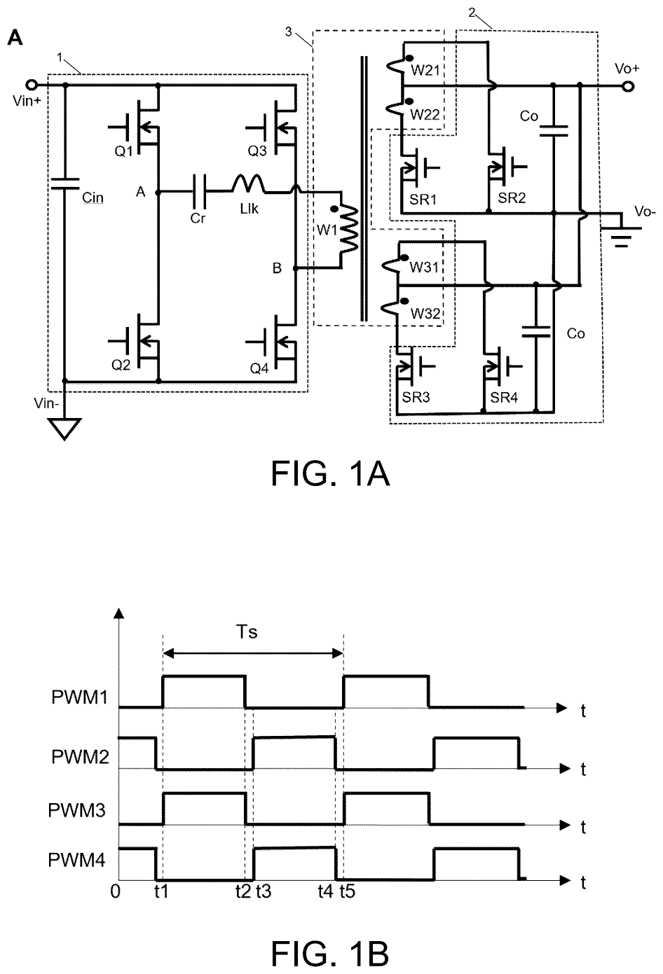

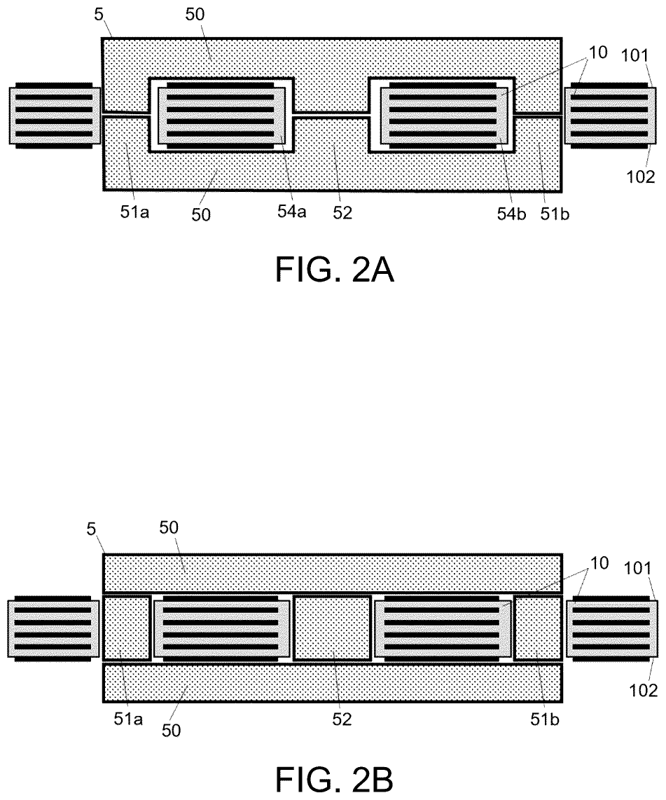

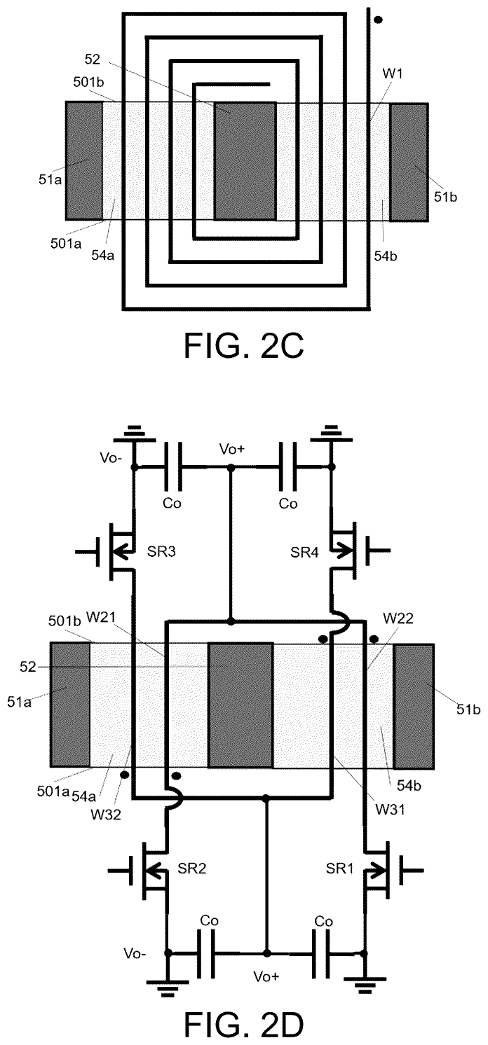

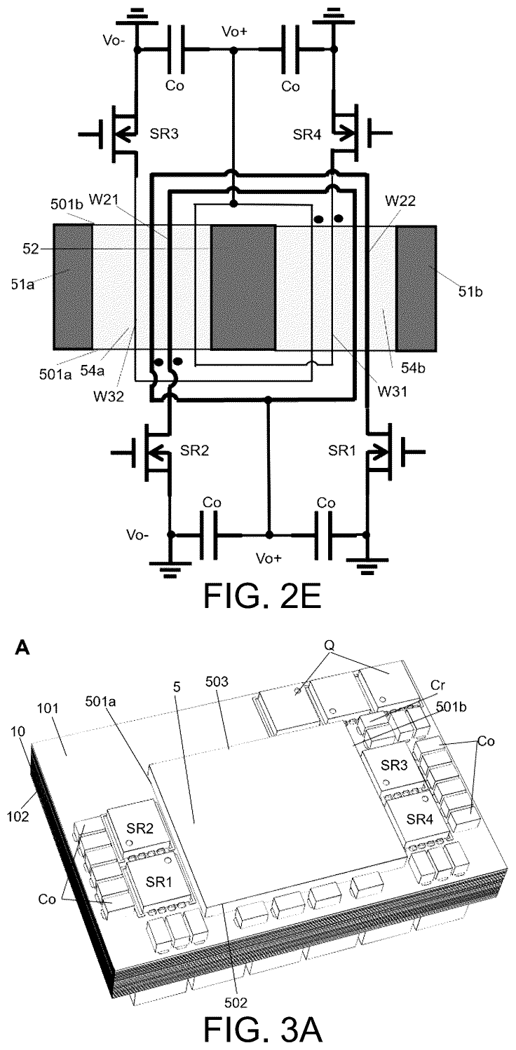

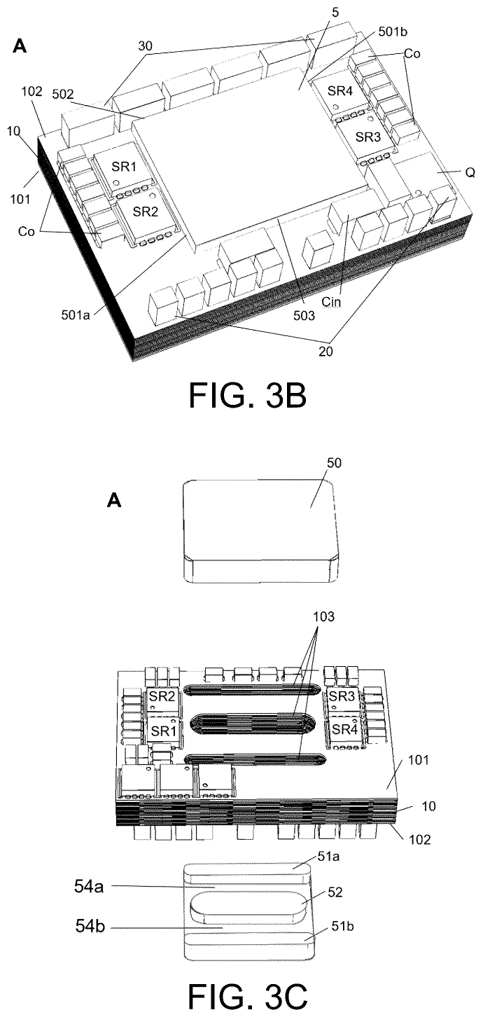

FIG. 1A shows a schematic diagram of a circuit topology corresponding to power modules Ain some embodiments. FIG. 1B is a timing diagram of control signals required by the power modules A. FIGS. 2A-2B are vertical cross-sectional views of two different structures of magnetic apparatuses in the power modules A. FIGS. 2C-2E are winding arrangements in the power modules A, wherein FIG. 2C is an arrangement of a high-voltage winding, and FIGS. 2D-2E are two different arrangements of low-voltage windings. FIGS. 3A-3C are schematic structural diagrams of a power module A in some embodiment, wherein FIG. 3A is a three-dimensional top view (Top) of the power module A, FIG. 3B is a three-dimensional bottom view (Bottom) of the power module A, and FIG. 3C is a top-view explosion diagram (Top) of the power module A.

As shown in FIG. 1A and FIG. 1B, the circuit topology corresponding to the power modules A comprises a high-voltage circuit 1, a low-voltage circuit 2 and an intermediate conversion circuit of a magnetic apparatus 3, wherein the high-voltage circuit 1 comprises an input positive terminal Vin+, an input negative terminal Vin−, at least one input capacitor Cin, two bridge arms of switches (i.e., high-voltage switches), a resonant capacitor Cr and an equivalent resonant inductor Llk. One bridge arm comprises an upper switch Q1 and a lower switch Q2, the switches Q1 and Q2 are electrically connected in series; and the other bridge arm comprises an upper switch Q3 and a lower switch Q4, and the switches Q3 and Q4 are electrically connected in series. The switches may be Si MOSFETs, GaN MOSFETs, SiC MOSFETs or IGBTs, etc. In the following disclosure, the switches are described as Si MOSFETs for example. Source of the switch Q1 is electrically connected with drain of the switch Q2 at the middle node A1 of one bridge arm; source of the switch Q3 is electrically connected with drain of the switch Q4 at the middle node B1 of the other bridge arm; and the two bridge arms are electrically connected in parallel and with the input capacitor Cin also in parallel between the input positive terminal Vin+ and the input negative terminal Vin−. The magnetic apparatus 3 is a transformer in some embodiments, and comprises a high-voltage winding W1, four low-voltage windings and a magnetically permeable core 5, wherein the high-voltage winding W1 and the four low-voltage windings are coupled to the same magnetically permeable core 5 (as shown in FIGS. 2A-2E); the resonant capacitor Cr, the equivalent resonant inductor Llk and the high-voltage winding W1 are electrically connected in series to form an LLC branch, one end of the LLC branch is electrically connected with the middle node A1 of the bridge arm, and the other end of the LLC branch is electrically connected with the middle node B1 of the bridge arm. A first end of the high-voltage winding W1 is electrically connected with the equivalent resonant inductor Llk, and a second end of the high-voltage winding W1 is electrically connected with the middle node B1 of the bridge arm; the four low-voltage windings are respectively low-voltage winding W21, low-voltage winding W22, low-voltage winding W31 and low-voltage winding W32; the low voltage windings W21 and W22 are referred to as a first winding group, wherein a second end of the low-voltage winding W21 is electrically connected with a second end of the low-voltage winding W22; and the low-voltage windings W31 and W32 are referred to as a second winding group, wherein a second end of the low-voltage winding W31 is electrically connected with a second end of the low-voltage winding W32. The low-voltage circuit 2 comprises output positive terminals Vo+, output negative terminals Vo−, two switching circuits and at least one output capacitor Co; the output capacitor Co is electrically connected between the output positive terminal Vo+ and the output negative terminal Vo−; the two switching circuits are respectively a first switching circuit and a second switching circuit. The first switching circuit comprises two synchronous rectification switches SR1 and SR2 (i.e., low-voltage switches); sources of the switches SR1 and SR2 are short-circuited and electrically connected to the output negative terminal Vo− (i.e., negative voltage terminal of the output capacitor Co); drain of the switch SR1 is electrically connected with a first end of the low-voltage winding W22; drain of the switch SR2 is electrically connected with a first end of the low-voltage winding W21; and the second ends of the low-voltage windings W22 and W21 are electrically connected to the output positive terminal Vo+. The second switching circuit comprises two synchronous rectification switches SR3 and SR4; sources of the switches SR3 and SR4 are short-circuited and electrically connected to the output negative terminal Vo−; drain of the switch SR3 is electrically connected with a first end of the low-voltage winding W32; drain of the switch SR4 is electrically connected with a first end of the low-voltage winding W31; and the second ends of the low-voltage windings W32 and W31 are electrically connected to the output positive terminal Vo+. The high-voltage winding W1 and the four low-voltage windings W21/W22/W31/W32 are magnetically coupled with the magnetically permeable core 5 in a winding direction that the first end of the high-voltage winding W1, the first end of the low-voltage winding W21, the second end of the low-voltage winding W22, the first end of the low-voltage winding W31 and the second end of the low-voltage winding W32 have the same polarity and are marked as dotted ends, and meanwhile, the second end of the high-voltage winding W1, the second end of the low-voltage winding W21, the first end of the low-voltage winding W22, the second end of the low-voltage winding W31 and the first end of the low-voltage winding W32 have the same polarity and are marked as non-dotted ends. In some embodiments, the input negative terminal Vin- and the output negative terminal Vo− are not short-circuited for the electrical isolation between input and output. In some other embodiments where input and output are not isolated, the input negative terminal Vin- and the output negative terminal Vo− are short-circuited. In some embodiments, a bridge arm of capacitors is configured to substitute for one of the bridge arms of switches, comprising at least two capacitors which are electrically connected in series; other parts of the circuit are in accordance with those shown in FIG. 1A, and details are not described again.

The circuit topology disclosed in FIG. 1A is a full-bridge LLC circuit topology, and FIG. 1B is a timing diagram of control signals in the full-bridge LLC circuit topology, wherein the period from time point t1 to time point t5 indicated by the dotted line is a switching period Ts; control signals PWM1-4 are in a same frequency and the duty ratios are less than and close to 50%, wherein the control signal PWM1 (referred to as a first control signal) and the control signal PWM2 (referred to as a second control signal) are in a phase offset of 1800 (half wave), the control signal PWM4 is an inverted signal of the control signal PWM1, and the control signal PWM3 is an inverted signal of the control signal PWM2 (with insertions of dead time). With the dead time t2-t3 and t4-t5 ignored, the duty ratios of the control signals PWM1-4 are all considered to be 50%. The control signal PWM1 is configured for controlling the switches Q1 and Q4; the control signal PWM2 is configured for controlling the switches Q2 and Q3; the control signal PWM3 is configured for controlling the switches SR1 and SR3; and the control signal PWM4 is configured for controlling the switches SR2 and SR4. The dead time between the control signals PWM4 and PWM1 and the dead time between the control signal PWM3 and the control signal PWM2 are configured for preventing the low-voltage windings from being short-circuited; according to the timing diagram as shown in FIG. 1B, the resonant capacitor Cr and the equivalent resonant inductor Llk resonates with the periodically switching of the eight switches, and the current through the resonant capacitor Cr is approximately in an sinusoidal waveform; when the amplitude of the resonant current through the equivalent resonant inductor Llk decreases and becomes close to the magnetizing current through the high-voltage winding W1, the control signal PWM1 or the control signal PWM2 is switched from a high level to a low level for a low-current turn-off of the switches Q1-Q4; the configuration of the dead time between the control signals PWM1 and PWM2, that is, the configuration of the intervals before the time points when the control signal PWM1 or the control signal PWM2 is switched from a low level to a high level, provides a ZVS turn-on of the switches Q1-Q4 resulting from the magnetizing current through the high-voltage winding W1; correspondingly, the control signal PWM3 or the control signal PWM4 is switched from a high level to a low level, and a ZCS turn-off of the switches SR1-SR4 is achieved. In some embodiments, a parasitic leakage inductance of the transformer is configured as the equivalent resonant inductor Llk; in some other embodiments an additional inductor or a combination of an additional inductor and a parasitic leakage inductance is provided and configured as the equivalent resonant inductor Llk; and the lower the equivalent resonant inductance is, the less the electric energy is remained in the equivalent resonant inductor Llk at the low-current turn-off of the switches Q1-Q4, thus the less the power loss is.

The structure of the magnetic apparatus 3 of the power module A and the winding arrangement of the high-voltage winding and the low-voltage windings are shown in FIGS. 2A-2E. In some embodiments, the magnetically permeable core 5 comprises two E-shaped core sections, as shown in a side view in FIG. 2A, the power module A comprises a winding substrate 10, the winding substrate 10 is provided with a first surface 101 and a second surface 102 opposite to each other, and further comprises the high-voltage winding and the low-voltage windings. As shown in FIG. 3C, the winding substrate 10 is provided with a plurality of magnetically-permeable-core holes 103, the magnetically-permeable-core holes 103 are in one-to-one correspondence with core legs of the magnetically permeable core 5 and penetrate from the first surface 101 to the second surface 102, with core legs of the magnetically permeable core 5 passing through. The core sections cover the winding substrate 10 respectively from the first surface 101 and the second surface 102 and the magnetically permeable core 5 is coupled with the high-voltage winding and the low-voltage windings arranged in the winding substrate 10 to form the magnetic apparatus 3.

In terms of function, the magnetically permeable core 5 comprises two core plates 50, a winding core leg 52 and two non-winding core legs. The non-winding core legs comprise a first side core leg 51a and a second side core leg 51b, the core legs are located between the two core plates 50, wherein the winding core leg 52 is arranged between the two side core legs 51a/b, and the first side core leg 51a, the winding core leg 52 and the second side core leg 51b are sequentially arranged in the same direction; and the magnetically permeable core 5 is buckled with the winding substrate 10 from the first surface 101 and the second surface 102 of the winding substrate 10 and is coupled with the windings arranged in the winding substrate 10. The channel between the first side core leg 51a and the winding core leg 52 is a first winding channel 54a, the channel between the second side core leg 51b and the winding core leg 52 is a second winding channel 54b, and the first and second winding channels 54a/b are channels for the arrangement of the windings in the magnetic apparatus 3; and referring to FIG. 3A, after the magnetically permeable core 5 and the winding substrate 10 are assembled, the four side surfaces of the core plates 50 arranged on the first and second surfaces 101/102 respectively correspond to a first winding channel side 501a, a second winding channel side 501b, an output side 502 and an input side 503 of the magnetically permeable core 5, wherein the first and second winding channel sides 501a/b are opposite to each other, and the output side 502 and the input side 503 are opposite to each other. In some other embodiments, the magnetically permeable core 5 comprises an E-shaped core section and an I-shaped core section; and in some other embodiments as shown in FIG. 2B, the magnetically permeable core 5 comprises core legs and core plates which are all individual core sections. The structure of individual core sections shows a beneficial effect that when the three core legs are respectively disposed through the magnetically-permeable-core holes 103 in the winding substrate 10, only the tolerance of the sizes of the core legs needs to be considered, and the tolerance of the distances between the core legs does not need to be considered. Due to the fact that the sizes of the core legs are far smaller than the distances between the core legs, the errors of the sizes of the core leg are far smaller than the errors of the distances between the core legs, so that the designed sizes of the magnetically-permeable-core holes 103 may be greatly reduced, thus the sizes of the winding channels are widened, the widths of the windings arranged in the winding substrate 10 are widened, and the parasitic resistance of the windings is reduced. The structure is particularly suitable for a magnetically permeable core structure with a plurality of core legs arranged in a row in that the more the core legs are provided, the longer the core plates are, the larger the errors of distances between the core legs are. The core legs are sectioned from the interface of the core plates and are individually formed, the errors of sizes of the magnetically permeable core in mass production may be remarkably reduced, and therefore the sizes of the magnetically-permeable-core holes 103 in the winding substrate 10 are greatly reduced. The core plates and the core legs aforementioned are in square shapes, and they are not limited thereto. According to the specifications of practical implementations, the core plates or the core legs may be circular, oval or polygonal and the like.

FIG. 2C is a perspective top-view diagram of the arrangement of the high-voltage winding W1 around the magnetically permeable core 5. The high-voltage winding W1 starts from the dotted end (i.e., the first end) shown in FIG. 2C, passes through the second winding channel 54b in a first direction (i.e., from top to bottom), passes through the first winding channel 54a in a second direction (i.e., from bottom to top) and is wound clockwise around the winding core leg 52. Multi-turn winding is arranged on a same wiring layer of the winding substrate 10; and the winding arrangement of the high-voltage winding W1 is not limited thereto. As long as the high-voltage winding W1 passes alternately through the two winding channels and alternately in the first and second directions and is wound horizontally around the winding core leg 52 in a same direction, the multi-turn winding is not limited to being arranged within one wiring layer. In some embodiments, the high-voltage winding W1 is arranged on more than one wiring layer, and layer-to-layer electrical connections are formed through vias.

FIG. 2D is a schematic diagram of the arrangement of the low-voltage windings W21/W22/W31/W32 and the low-voltage circuit 2 around the magnetically permeable core 5. Sources of the switches SR1/SR2 are electrically connected to output negative terminals Vo−; drain of the switch SR2 is electrically connected to the dotted end (i.e., the first end) of the low-voltage winding W21; the low-voltage winding W21 passes through the first winding channel 54a from the dotted end in the second direction, and the non-dotted end (i.e., the second end) of the low-voltage winding W21 is electrically connected to an output positive terminal Vo+; drain of the switch SR1 is electrically connected to the non-dotted end (i.e., the first end) of the low-voltage winding W22; the low-voltage winding W22 passes through the second winding channel 54b from the non-dotted end in the second direction, and the dotted end (i.e., the second end) of the low-voltage winding W22 is electrically connected to the output positive terminal Vo+. The first ends of the low-voltage windings W21/W22 are arranged on the first winding channel side 501a; the second ends of the low-voltage windings W21/W22 are arranged on the second winding channel side 501b; the first winding group (i.e., the low-voltage winding W21 and the low-voltage winding W22) is wound clockwise from the dotted end of the low-voltage winding W21 to the non-dotted end of the low-voltage winding W22 around the winding core leg 52 for one turn in total, that is, the low-voltage winding W21 is wound around the winding core leg 52 for 0.5 turn, the low-voltage winding W22 is wound around the winding core leg 52 for another 0.5 turn, and the first winding group is located on a same wiring layer of the winding substrate 10. The low-voltage winding W21 and the low-voltage winding W22 may also be formed on different wiring layers of the winding substrate 10, and short-circuited through a via which is also electrically connected to the output positive terminal Vo+. Similarly, sources of the switches SR3/SR4 are electrically connected to output negative terminals Vo−; drain of the switch SR4 is electrically connected to the dotted end (i.e., the first end) of the low-voltage winding W31; the low-voltage winding W31 passes through the second winding channel 54b from the dotted end in the first direction, and the non-dotted end (i.e., the second end) of the low-voltage winding W31 is electrically connected to an output positive terminal Vo+; drain of the switch SR3 is electrically connected to a non-dotted end (i.e., the first end) of the low-voltage winding W32, the low-voltage winding W32 passes through the first winding channel 54a from the non-dotted end in the first direction, and the dotted end (i.e., the second end) of the low-voltage winding W32 is electrically connected to the output positive terminal Vo+. The first ends of the low-voltage windings W31/W32 are arranged on the second winding channel side 501b; the second ends of the low-voltage windings W31/W32 are arranged on the first winding channel side 501a, the second winding group (i.e., the low-voltage winding W31 and the low-voltage winding W32) is wound clockwise around the winding core leg 52 from the dotted end of the low-voltage winding W31 to the non-dotted end of the low-voltage winding W32 for one turn in total, that is, the low-voltage winding W31 is wound around the winding core leg 52 for 0.5 turn, the low-voltage winding W32 is wound around the winding core leg 52 for another 0.5 turn, and the second winding group is located on a same wiring layer of the winding substrate 10. The low-voltage winding W31 and the low-voltage winding W32 may also be formed on different wiring layers of the winding substrate 10 and short-circuited through a via which is also electrically connected to the output positive terminal Vo+. At least two output capacitors Co are respectively arranged on two opposite sides of the magnetically permeable core 5, that is, on the first winding channel side 501a and on the second winding channel side 501b, and are bridged between the output positive terminal Vo+ and the output negative terminal Vo− of each side. The output positive terminals Vo+ on the two opposite sides of the magnetically permeable core 5 are short-circuited, and the output negative terminals Vo− on the two opposite sides of the magnetically permeable core 5 are short-circuited. According to the 0.5-turn structure and the winding arrangement of the low-voltage windings and the layout of the corresponding low-voltage circuit 2 disclosed in the aforementioned embodiments, the path of the low-voltage windings are short, the impedance is low, the power loss on the low-voltage windings is reduced, and the first and second switching circuits are arranged on the two opposite sides of the magnetically permeable core 5 respectively. Compared with the structure that the first and second switching circuits are arranged on a same side of the magnetically permeable core 5, the first ends and the second ends of each low-voltage winding group are arranged on the two opposite winding channel sides, and the first and second switching circuits are also arranged on the two opposite winding channel sides and adjacent to terminals of the winding channels; thus the space on the two opposite sides of the magnetically permeable core 5 is more fully utilized, occupied area of the first and second switching circuits and number of the switches are greatly increased to be doubled, the parasitic resistance on the switching circuits is reduced, and the conduction loss of the power module A is reduced. Further, the low-voltage windings W21/W22 are arranged in different winding channels respectively; by comparing the current flowing through the low-voltage winding W21 with the current flowing through the low-voltage winding W22, it can be seen that amplitudes and directions of the direct-current current components are the same, and amplitudes of the alternating-current components are essentially the same with a phase shift of 180°. Similarly, by comparing the current flowing through the low-voltage winding W31 with the current flowing through the low-voltage winding W32, it can be seen that amplitudes and directions of the direct-current components are the same, and amplitudes of the alternating current components are essentially the same with a phase shift of 180°. The low-voltage winding W21 and the low-voltage winding W32 are arranged though the same winding channel, that is, the first winding channel 54a; by comparing the current flowing through the low-voltage winding W21 with the current flowing through the low-voltage winding W32, it can be seen that directions of the direct-current components are opposite with amplitudes approximately the same, and the amplitudes and phases of the alternating current components are the same. Similarly, the low-voltage winding W22 and the low-voltage winding W31 are arranged through the same winding channel, that is, the second winding channel 54b; by comparing the current flowing through the low-voltage winding W22 with the current flowing through the low-voltage winding W31, it can be seen that, directions of the direct-current components are opposite with amplitudes approximately the same, and the amplitudes and phases of the alternating current components are the same. Within either winding channel, by comparing sum of the currents flowing through the low-voltage windings with the current flowing through the high-voltage winding (multiplied by the number of turns), it can be seen that amplitudes of the direct-current components of the two are essentially 0, and amplitudes of the alternating-current components of the two are approximately the same with the current directions approximately opposite. The aforementioned winding arrangement shows beneficial effects that the two low-voltage windings and one high-voltage winding in either winding channel are provided with a minimized alternating-current resistance and a reduced conduction loss.

The winding arrangement of the low-voltage windings is not limited thereto. In some embodiments, another winding arrangement of the low-voltage windings is shown in FIG. 2E, different from that of the embodiment according to FIG. 2D. The low-voltage winding W21 passes through the first winding channel 54a in the second direction from the dotted end (i.e., the first end) and then passes through the second winding channel 54b in the first direction, and the non-dotted end (i.e., the second end) of the low-voltage winding W21 is electrically connected to an output positive terminal Vo+; the low-voltage winding W22 passes through the second winding channel 54b from the non-dotted end (i.e., the first end) in the second direction and then passes through the first winding channel 54a in the first direction, and the dotted end (i.e., the second end) of the low-voltage winding W22 is electrically connected to the output positive terminal Vo+. Therefore the first and second ends of the low-voltage windings W21/W22 are arranged on the first winding channel side 501a; the first winding group (i.e., the low-voltage winding W21 and the low-voltage winding W22) is wound around the winding core leg 52 clockwise from the dotted end of the low-voltage winding W21 to the non-dotted end of the low-voltage winding W22 for two turns in total, that is, the low-voltage winding W21 is wound around the winding core leg 52 for one turn and the low-voltage winding W22 is wound around the winding core leg 52 for another one turn. Similarly, the low-voltage winding W31 passes through the second winding channel 54b from the dotted end (i.e., the first end) in the first direction and then passes through the first winding channel 54a in the second direction, and the non-dotted end (i.e., the second end) of the low-voltage winding W31 is electrically connected to an output positive terminal Vo+; the low-voltage winding W32 passes through the first winding channel 54a in the first direction from the non-dotted end (i.e., the first end) and then passes through the second winding channel 54b in the second direction, and the dotted end (i.e., the second end) of the low-voltage winding W32 is electrically connected to the output positive terminal Vo+. Therefore, the first and second ends of the low-voltage windings W31/W32 are arranged on the second winding channel side 501b; the second winding group (i.e., the low-voltage winding W31 and the low-voltage winding W32) is wound around the winding core leg 52 clockwise from the dotted end of the low-voltage winding W31 to the non-dotted end of the low-voltage winding W32 for two turns in total, that is, the low-voltage winding W31 is wound around the winding core leg 52 for one turn and the low-voltage winding W32 is wound around the winding core leg 52 for another one turn. The low-voltage windings arranged in 1-turn structure also shows the technical effects as in the 0.5-turn structure, with the first ends of the two windings in the first winding group and the first ends of the two windings in the second winding group arranged towards the opposite sides respectively and correspondingly the first and second switching circuits arranged towards the opposite sides respectively. Compared with the structure that the first switching circuit and the second switching circuit are arranged on the same side of the magnetically permeable core 5, the space on the two opposite sides is more fully utilized, so that the occupied area of the first and second switching circuits and the number of the switches are greatly increased to be doubled, the parasitic resistance on the switching circuits is reduced, and the conduction loss of the power module A is reduced.

FIGS. 3A-3C show a three-dimensional structure diagram of the power module A, wherein FIG. 3A is a top view, FIG. 3B is a bottom view, and FIG. 3C is a top-view explosion diagram. As shown in FIG. 3A, the power module A comprises a winding substrate 10, a magnetically permeable core 5, a plurality of high-voltage switches Q, a plurality of synchronous rectification switches SR1-SR4, at least one input capacitor Cin (i.e., high-voltage capacitor), and at least one output capacitor Co (i.e., low-voltage capacitor), input pins 20 and output pins 30. The switches SR1/SR2 in the first switching circuit arranged on a first surface 101 are both disposed on the first winding channel side 501a, and positions of sources of the switches SR1/SR2 are arranged close to each other and short-circuited to form a synchronous rectification source node of the first switching circuit; the switches SR3/SR4 in the second switching circuit are disposed on the second winding channel side 501b, and positions of sources of the switches SR3/SR4 are arranged close to each other and short-circuited to form a synchronous rectification source node of the second switching circuit. The switch SR3 and the switch SR2 are opposite in position, and the switch SR1 and the switch SR4 are opposite in position; and at least two output capacitors Co are symmetrically arranged respectively on the outer sides of the switches SR1-SR4. A plurality of high-voltage switches Q are disposed on the input side 503. As shown in FIG. 3C, in the winding substrate 10, the regions between two adjacent magnetically-permeable-core holes 103 respectively correspond to the first winding channel 54a and the second winding channel 54b after the magnetically permeable core 5 is assembled with the winding substrate 10; the low-voltage windings W21/W22 correspondingly pass through the first winding channel 54a or the second winding channel 54b; the first ends of the low-voltage windings W21/W22 are arranged on the first winding channel side 501a, and the second ends of the low-voltage windings W21/W22 are arranged on the second winding channel side 501b. The low-voltage windings W31/W32 correspondingly pass through the second winding channel 54b or the first winding channel 54a; the first ends of the low-voltage windings W31/W32 are arranged on the second winding channel side 501b, the second ends of the low-voltage windings W31/W32 are arranged on the first winding channel side 501a. On the first winding channel side 501a, the switch SR1 is placed close to the second winding channel 54b, with drain of the switch SR1 electrically connected to the first end of the low-voltage winding W22 in a shortest distance; the switch SR2 is placed close to the first winding channel 54a, with drain of the switch SR2 electrically connected to the first end of the low-voltage winding W21 in a shortest distance; the switch SR3 is placed close to the first winding channel 54a, with drain of the switch SR3 electrically connected to the first end of the low-voltage winding W31 in a shortest distance; and the switch SR4 is placed close to the second winding channel 54b, with drain of the switch SR4 electrically connected to the first end of the low-voltage winding W32 in a shortest distance.

In some embodiments, the first output capacitor Co, the first switching circuit, the magnetically permeable core 5, the second switching circuit and the second output capacitor Co are arranged along a device position line, the device position line is defined as a straight line penetrating through the two opposite sides of the winding substrate 10, the device position line penetrates through the at least one output capacitor, one synchronous rectification switch, the magnetically permeable core, another synchronous rectification switch and at least one another output capacitor. The output capacitors Co are symmetrically arranged on the outer sides of the synchronous rectification switches. On one hand, the drains of the switches SR1/SR2 are connected with the first ends of the low-voltage windings W22/W21 in the shortest distance; the sources of the switches SR1/SR2 are close to each other; the alternating-current loop formed by the switch SR1, the low-voltage winding W22, the low-voltage winding W21 and the switch SR2 is minimized; and the parasitic leakage inductance and the alternating-current resistance of the loop are greatly reduced. On the other hand, the drains of the switches SR3/SR4 are connected to the first ends of the low-voltage windings W31/W32 in the shortest distance; the sources of the switches SR3/SR4 are close to each other; the alternating-current loop formed by the switch SR3, the low-voltage winding W32, the low-voltage winding W31 and the switch SR4 is minimized; and the parasitic leakage inductance and the alternating-current resistance of the loop are greatly reduced.

Similarly, the switches SR1/SR2 in the first switching circuit arranged on the second surface 102 are both disposed on the first winding channel side 501a, and positions of sources of the switches SR1/SR2 are close to each other and short-circuited to form a synchronous rectification source node of the first switching circuit; the switches SR3/SR4 in the second switching circuit are arranged on the second winding channel side 501b, and positions of sources of the switches SR3/SR4 are close to each other and short-circuited to form a synchronous rectification source node of the second switching circuit. The switch SR3 and the switch SR2 are opposite in position, and the switch SR1 and the switch SR4 are opposite in position; the input pins 20 are arranged on the input side 503, the output pins 30 are arranged on the output side 502, the angle between the relative position vector from any one of the output pins 30 to another and the output side 502 is smaller than or equal to 45 degrees; at least two output capacitors Co are respectively and symmetrically arranged on the outer side of the switches SR1-SR4. In some embodiments, positions of the output capacitors Co and the switches SR1-SR4 arranged on the first surface 101 of the winding substrate 10 are in one-to-one correspondence with those on the second surface 102, that is, the position of the output capacitor Co arranged on the first surface 101 partially overlaps or wholly coincides with a projection position to the first surface 101 of the corresponding output capacitor Co arranged on the second surface 102, and the position of the synchronous rectification switch arranged on the first surface 101 partially overlaps or wholly coincides with a projection position to the first surface 101 of the corresponding synchronous rectification switch arranged on the second surface 102, so that device pins may be short-circuited by vertical vias through the winding substrate 10 just at the positions of bonding pads of the device pins as well as other kind of vias. In detail, on the first winding channel side 501a, positive device pin of the output capacitor Co located on the first surface 101 and positive device pin of the output capacitor Co located on the second surface 102 are short-circuited by the vertical via in the position of their bonding pads or other kind of vias through the winding substrate 10; and negative device pin of the output capacitor Co located on the first surface 101 and the negative device pin of the output capacitor Co located on the second surface 102 are also short-circuited by the vertical via in the position of their bonding pads or other kind of vias through the winding substrate 10. The sources of the switches SR1/SR2 located on the first surface 101 are respectively short-circuited with the sources of the switches SR1/SR2 located on the second surface 102 by the vertical vias in the position of their bonding pads or other kind of vias through the winding substrate 10; and the drains of the switches SR1/SR2 located on the first surface 101 are respectively short-circuited with the drains of the switches SR1/SR2 located on the second surface 102 by the vertical vias in the position of their bonding pads or other kinds of vias through the winding substrate 10. Arrangement of the output capacitors and the synchronous rectification switches on the second winding channel side 501b is consistent with the arrangement of the output capacitors and the synchronous rectification switches on the first winding channel side 501b.

According to the aforementioned arrangement, the synchronous rectification switches can be placed both on the first surface 101 and on the second surface 102 of the winding substrate 10, located on two opposite terminal sides of the winding channels of the magnetically permeable core 5, so that the number of the synchronous rectification switches is doubled and redoubled from two to eight. The increase of the number of synchronous rectification switches not only reduces the parasitic resistance, resulting in a decrease of the switching loss on the synchronous rectification switches, but also increases the number of connecting nodes between the switching circuits and the low-voltage windings from two to eight, resulting in a decrease of the conduction loss on the connecting nodes; thus the conversion efficiency of the power module A is greatly improved. Further, on the same surface of the winding substrate 10 and at the same side of the winding channels of the magnetically permeable core 5, the positions of the sources of the synchronous rectification switches in the same switching circuit are adjacent and short-circuited and are adjacent to the magnetically permeable core, and the output capacitors are placed adjacent to the outer side of the synchronous rectification switches, so that alternating current loop formed by the low-voltage windings and the corresponding switching circuit is minimized, and the conduction loss of the alternating current in the loop is minimized.

At least three output pins 30 are provided. In some embodiments, the three output pins may be configured as two output positive terminals Vo+ and one output negative terminal Vo−, and are sequentially arranged in an array of an output positive terminal Vo+, an output negative terminal Vo- and an output positive terminal Vo+, and may also be two output negative terminals Vo- and one output positive terminal Vo+, and are sequentially arranged in an array of an output negative terminal Vo−, an output positive terminal Vo+ and an output negative terminal Vo−. In some embodiments, six output pins 30 are provided and configured alternately in a first electrical property and in a second electrical property, that is, in an array of three pairs of output positive and negative terminals Vo+ and Vo−; the six output pins are arranged along one side edge of the power module A in an array. A side surface of the magnetically permeable core 5 facing the output pins 30 is referred to as an output side 502; a side surface opposite to the output side 502 is referred to as an input side 503; and the first winding channel side 501a and the second winding channel side 501b are respectively located between the output side 502 and the input side 503. In such a layout of arrangement, on the first hand, the shortest distance from the second ends of the two low-voltage windings extending out of the first winding channel side 501a to the output pins may be provided approximately equal to the shortest distance from the second ends of the two low-voltage windings extending out of the second winding channel side 501b to the output pins, so that the impedance from the second end of the low-voltage windings in the first winding group to the output pins is approximately equal to the impedance from the second end of the low-voltage windings in the second winding group to the output pins. On the second hand, the shortest distance from the synchronous rectification source node of the first switching circuit to the output pins is approximately equal to the shortest distance from the synchronous rectification source node of the second switching circuit to the output pins, so that the impedance of the synchronous rectification source node of the first switching circuit to the output pins is approximately equal to the impedance of the synchronous rectification source node of the second switching circuit to the output pins. On the third hand, the sum of the shortest distance from the second ends of the two windings of the second winding group to the output pins plus the shortest distance from the synchronous rectification source node of the first switching circuit to the output pins is approximately equal to the sum corresponding to the first winding group and the second switching circuit. With any of the three aforementioned criteria met, current self-equalization is achieved between the first switching circuit and the second switching circuit.

The input pins 20 includes at least one input positive pin Vin+ and a plurality of signal pins, and the signal pins are disposed on two sides of the input positive pin Vin+. In some embodiments, referring to FIG. 3A and FIG. 3B, the input capacitors Cin are also disposed between the magnetically permeable core 5 and the input positive pin Vin+, and the high-voltage switches are disposed on the first surface 101 and the second surface 102 of the winding substrate and near the corner of the second channel side 501b and the input side 503; both ends of the high-voltage winding W1 are arranged on the second winding channel side 501b; one end of the high-voltage winding W1 is electrically connected to the middle node of one bridge arm of the high-voltage circuit 1, and the other end of the high-voltage winding W1 is electrically connected with the resonant capacitor Cr arranged on the first surface 101, the resonant capacitor Cr then electrically connected to the middle node of the other bridge arm.

As shown in FIG. 3C, the configuration of air gaps which section the three core legs and the resulting reluctance of the magnetically permeable core are as follows: in some embodiments, heights of the air gaps at the first side core leg 51a and the second side core leg 51b are configured to be approximately equal and relatively small or close to 0, resulting in low-reluctance legs; heights of the air gap at the winding core leg 52 is larger than that at the first and second side core legs 51a/b, resulting in a high-reluctance leg, so that sufficient magnetization current is generated in the high-voltage winding W1 for ZVS turn-on in the high-voltage circuit 1. In some other embodiments, the air gaps at the first side core leg 51a, at the second side core leg 51b and at the winding core leg 52 are the same in height; the configuration of the same heights of the air gaps at the three core legs shows beneficial effects that on one hand, no further processing step on the winding core leg 52 for setting the height of the air gap is required, the magnetically permeable core easy to form and assemble, and on the other hand, on meeting the requirements that a sufficient magnetization current is generated in the high-voltage winding W1 for ZVS turn-on in the high-voltage circuit 1, the air gap at the winding core leg 52 is reduced, and the air gaps of the first and second side core legs 51a/b are increased, so that the total amount of eddy current loss generated on the windings by the magnetic flux leakage from the air gaps at the three core legs is reduced, the light-load power loss of the power module A is reduced, and the heavy-load conversion efficiency of the power module A is improved.

### Embodiment 2

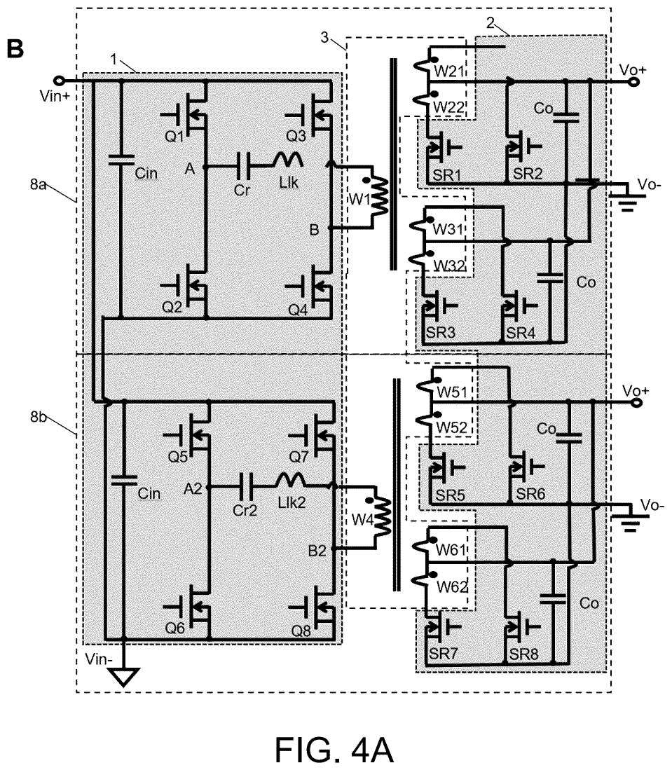

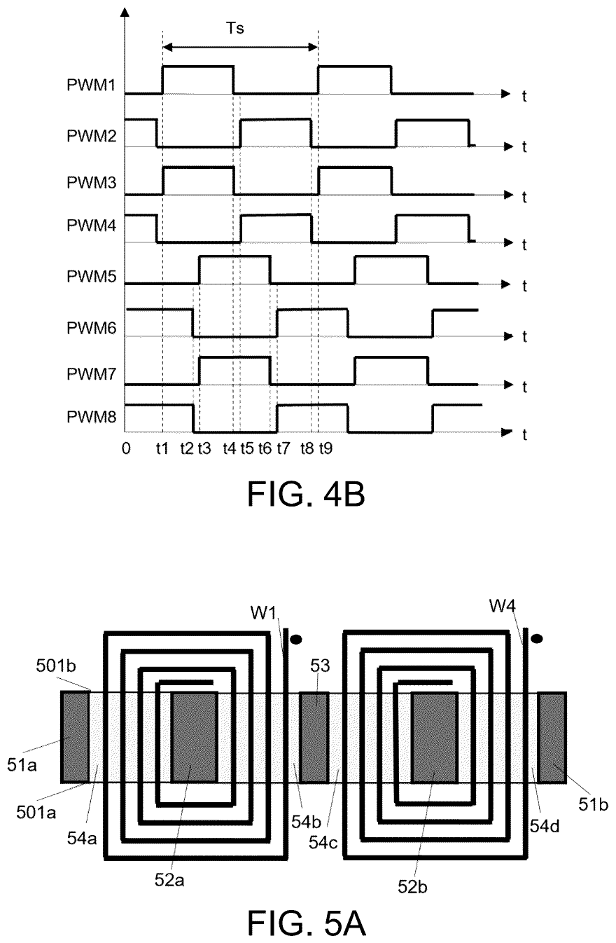

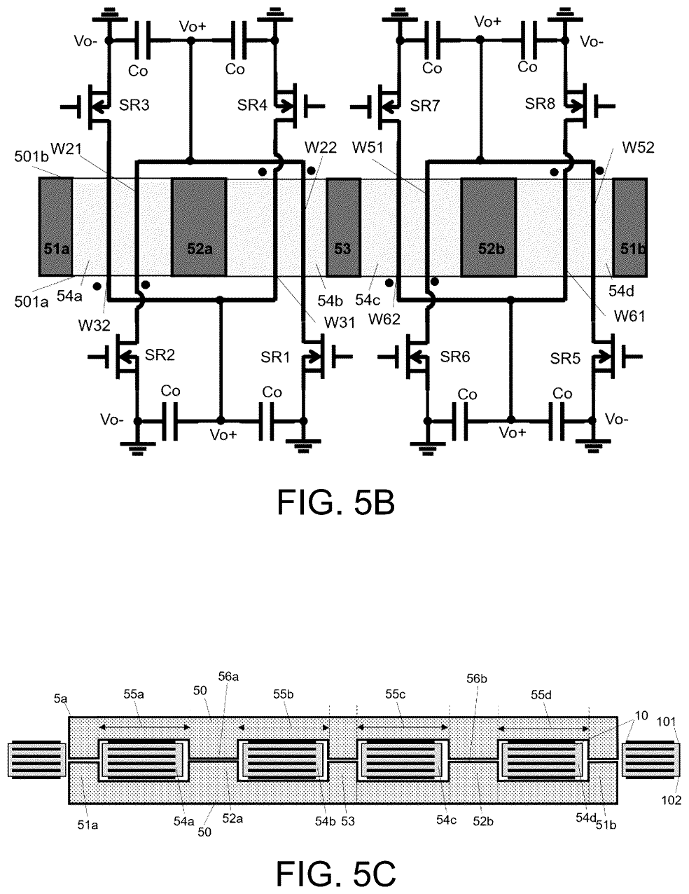

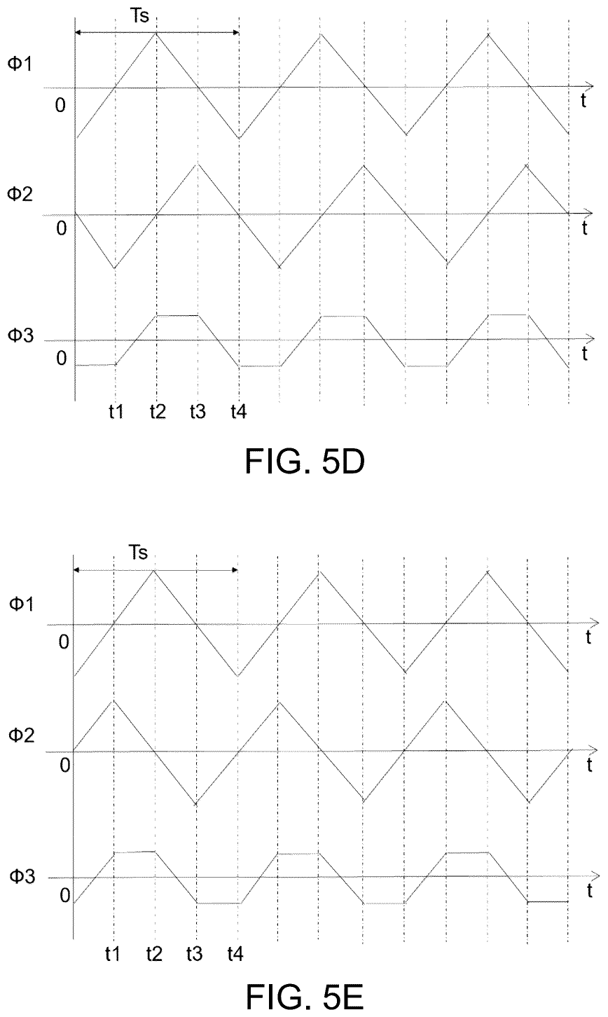

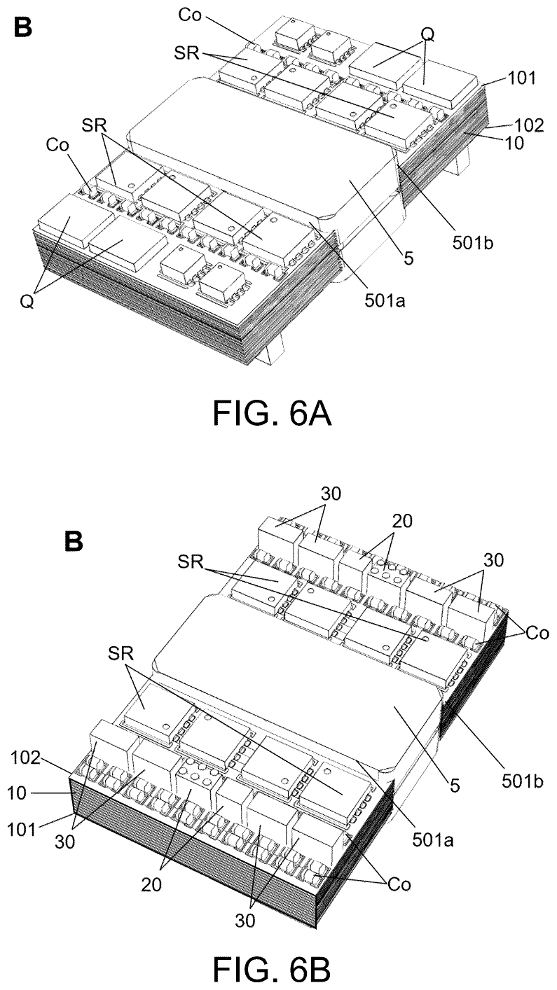

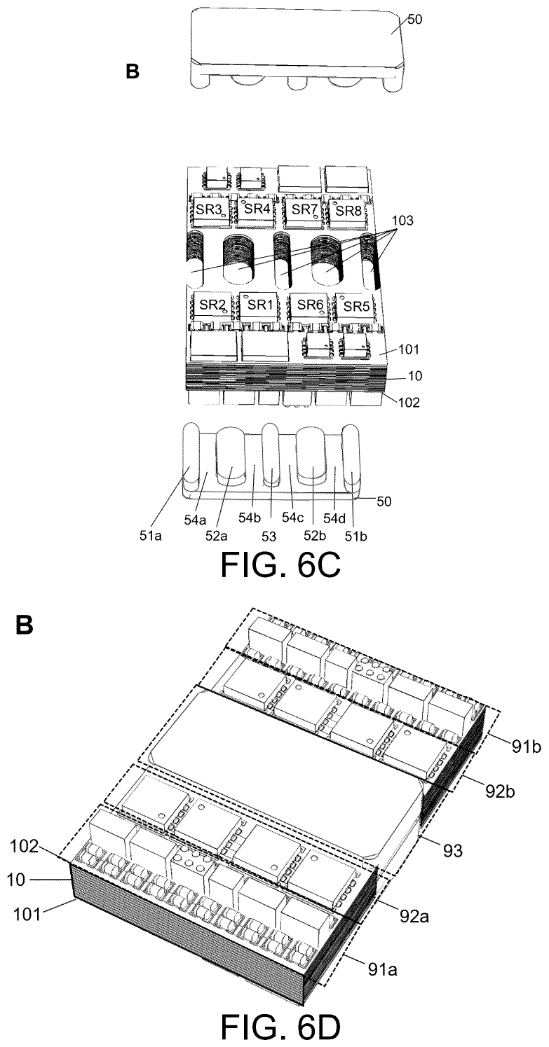

FIG. 4A shows a schematic diagram of circuit topology corresponding to a power module B disclosed in the present embodiment, and FIG. 4B is a timing diagram of control signals required by the power module B. FIG. 5A to FIG. 5E disclose a winding arrangement, a structure of a magnetically permeable core, and variation trends of the magnetic flux over time in a working state, and FIGS. 6A-6C show a schematic structural diagram of a power module B, wherein FIG. 6A is a three-dimensional top view (TOP) of the power module B, FIG. 6B is a three-dimensional bottom view (BOTTOM) of the power module B, and FIG. 6C is a top-view explosion diagram (TOP) of the power module B.

In Embodiment 1, referring to the circuit topology shown in FIG. 1A, when the switches in the high-voltage circuit 1 are turned off, the electric energy remained in the equivalent resonant inductor Llk is dissipated, and in order to reduce the loss, the inductance of the equivalent resonant inductor Llk is configured to be minimized, so that the energy remained in the equivalent resonant inductor Llk is correspondingly reduced, the loss is reduced, and the efficiency is improved; from another point of view, in order to meet the specification of a same resonant frequency of the power module, the capacitance of the resonant capacitor Cr is configured to be increased inversely proportional to the decrease of the inductance of the equivalent resonant inductor Llk; with the increase of the capacitance of the resonant capacitor Cr, in order to avoid the influence on the resonance period by the ripple voltage between the two ends of the output capacitors Co in the power module, the capacitance of the output capacitors Co in the power module is configured to be correspondingly increased. In general, the equivalent capacitance of the output capacitors Co in the power module is K×K times or more than the equivalent capacitance of the resonant capacitor Cr, (here, K is the gain ratio of the input voltage Vin to the output voltage Vo, namely K=Vin/Vo; the equivalent capacitance does not refer to the nominal capacitance of the capacitor, but to the real capacitance of the capacitors in a working state with the consideration of the influence of various factors on the capacitance such as the DC bias voltage component of the capacitors, the temperature of the capacitors, the AC voltage component of the capacitors, etc.). The capacitance of the resonant capacitor Cr is increased, so that the capacitance of the output capacitors Co in the power module is also increased along with the increase of that of the resonant capacitor Cr, that is, more output capacitors Co in the power module are provided and/or the output capacitors Co are provided with larger sizes, which deviates from the aim of a small size of the power module. In some embodiments, in order to reduce the number and the size of the output capacitors Co in the power module, and to meet the requirement of a small size of the power module, circuit topology of the power module B is disclosed as follows. Referring to the circuit topology shown in FIG. 4A, two circuit units with module-A topology as shown in FIG. 1A are provided, input terminals connected in parallel and output terminals also connected in parallel, that is, in a dual module-A topology, four bridge arms of high-voltage switches are connected in parallel, and second ends of eight low-voltage windings are short-circuited (via the output voltage terminals Vo+) together. Each circuit unit of module-A topology corresponds to a set of control signals, and the two sets of control signals are in a phase offset of 90° (¼ wave). By comparing with the situation that two sets of control signals are in a same phase (hereinafter referred to as a comparative example), it can be seen that the frequency of the output current (which is in a waveform of sinusoidal half-wave) at the short contact of the eight low-voltage windings of the power module B is four times of switching frequency, and the frequency of the output current at the short-contact of the eight low-voltage windings of comparative example is twice the switching frequency; at aspect of a same output capacitance, the ripple voltage amplitude of the output terminal in the power module B is greatly reduced, and at aspect of a same output terminal ripple voltage amplitude, the capacitance of the output capacitors in the power module B may be greatly reduced, number and size of the output capacitors Co correspondingly greatly reduced. In order to avoid the influence on the resonance period by the ripple voltage at the output terminals in the power module of the comparative example, the equivalent total capacitance of the output capacitors Co in the power module is usually N×K×K times or more than the equivalent capacitance of the resonant capacitor Cr or Cr2 (the resonant capacitor Cr or Cr2 is shown in FIG. 4A, N is the number of circuit units, i.e., N is equal to 2 in this example, and K is gain ratio of the input and output voltages, namely K=Vin/Vo); while in the power module B, the equivalent total capacitance of the output capacitors Co may be smaller than not only N×K×K times of the equivalent capacitance of the resonant capacitor Cr or Cr2, but also 0.5×N×K×K times or even 0.25×N×K×K times of the equivalent capacitance of the resonant capacitor Cr or Cr2. In a steady state operation, the optimal equivalent total capacitance of the output capacitor Co in the power module B is smaller than 0.25×N×K×K times of the equivalent capacitance of the resonant capacitor Cr or Cr2.

Similarly, the input capacitors Cin in the power module B may also shows the beneficial effects. Compared with the comparative example, the frequency of the input current in sinusoidal half-wave waveform at the short contact of the four bridge arms in the power module B is also increased from two times of the switching frequency to four times of the switching frequency; at aspect of a same input capacitance, the input terminal ripple voltage amplitude in the power module B is also greatly reduced; at aspect of a same input terminal ripple voltage amplitude, the input capacitance in the power module B may be greatly reduced, number and size of the input capacitors Cin correspondingly greatly reduced. In order to avoid the influence on the resonance period by the ripple voltage at the input terminals in the power module of the comparative example, the equivalent total capacitance of the input capacitors Cin in the power module is usually N times or more than the equivalent total capacitance of the resonant capacitors Cr/Cr2 (N is the number of the circuit units, i.e., n is equal to 2); while in the power module B, the equivalent total capacitance of the input capacitors Cin may be smaller than not only N times of the equivalent total capacitance of the resonant capacitors Cr/Cr2, but also 0.5×N times or even 0.25×N times of the equivalent total capacitance of the resonant capacitors Cr/Cr2.

According to the circuit topology shown in FIG. 4A, the power module A shown in FIG. 1A to FIG. 3C is expanded by parallel connections of a plurality of circuit units 8a/b. In the embodiments as mentioned above and as follows, two circuit units are provided for example, the two circuit units are respectively a first circuit unit 8a and a second circuit unit 8b. The magnetic apparatus may be provided with individual parts for each circuit unit, and may also be provided with a five-leg magnetically permeable core 5a for two circuit units as shown in FIGS. 5A-5E. FIG. 5A shows a top perspective schematic diagram of the high-voltage windings W1/W4 around the magnetically permeable core 5a. FIG. 5B shows a winding arrangement for the low-voltage windings and the corresponding low-voltage circuit 2. FIG. 5C shows a vertical cross-sectional view of the magnetic apparatus. The magnetically permeable core 5a comprises five core legs, wherein two winding core legs and three non-winding core legs are provided and respectively referred to as a first side core leg 51a, a first winding core leg 52a, a public core leg 53, a second winding core leg 52b and a second side core leg 51b, arranged sequentially between two core plates 50. The cross sections of the first and second winding core legs 52a/b are approximately the same in shape and approximately equal in area; the cross sections of the first side core leg 51a, the public core leg 53 and the second side core leg 51b are approximately the same in shape and approximately equal in area; and cross sectional area of each of the first side core leg 51a, the public core leg 53 and the second side core leg 51b is approximately half of cross sectional area of each winding core leg 52a/b; the magnetically permeable core 5a is equivalent to the two magnetically permeable cores 5 arranged side by side, and the two adjacent side core legs are integrated into the public core leg 53; and the channels between every two adjacent core legs are respectively referred to as a first winding channel 54a, a second winding channel 54b, a third winding channel 54c and a fourth winding channel 54d, the high-voltage windings and the low-voltage windings passing through the winding channels. Parts of the two core plates 50 corresponding to top and bottom walls of each winding channel is referred to as channel walls 55a, channel walls 55b, channel walls 55c and channel walls 55d, and a cross-sectional area of each channel wall 55a/b/c/d is approximately half of cross sectional area of each winding core leg 52a/b.

As shown in FIG. 5A, a high-voltage winding W1 and a high-voltage winding W4 are wound around the magnetically permeable core 5a. Referring to FIG. 4A, the high-voltage winding W1 starts from a dotted end (i.e., a first end), passes through the second winding channel 54b in a first direction (i.e., from top to bottom), passes through the first winding channel 54a in a second direction (i.e., from bottom to top), and is horizontally wound clockwise around the first winding core leg 52a, multi-turn winding arranged on a same wiring layer of the winding substrate 10; similarly, the high-voltage winding W4 starts from a dotted end (i.e., a first end), passes through the fourth winding channel 54d in the first direction (i.e., from top to bottom), passes through the third winding channel 54c in the second direction (i.e., from bottom to top), and is horizontally wound clockwise around the second winding core leg 52b, multi-turn winding arranged on a same wiring layer of the winding substrate 10; the winding arrangement of the high-voltage windings W1/W4 are not limited thereto. As long as the high-voltage winding passes alternately through two adjacent winding channels and alternately in the first direction and the second direction and are wound around the winding core leg in a same direction, multi-turn winding is not limited to be arranged within one wiring layer. In some embodiments, the high-voltage winding W1/W2 are arranged on more than one wiring layer, and layer-to-layer electrical connections are formed through vias.

FIG. 5B is a schematic diagram of the low-voltage windings and the low-voltage circuit 2 arranged around the magnetically permeable core 5a, the winding arrangement and the connection arrangement of the synchronous rectification switches are similar to those shown in FIG. 2D. The first circuit unit 8a comprises two switching circuits and two winding groups; the two switching circuits are respectively a first switching circuit and a second switching circuit; the first switching circuit comprises a synchronous rectification switch SR2 and a synchronous rectification switch SR1; sources of the synchronous rectification switch SR2 and the synchronous rectification switch SR1 are electrically connected to output negative terminals Vo−; drain of the synchronous rectification switch SR2 is electrically connected to the dotted end (i.e., the first end) of the low-voltage winding W21, the low-voltage winding W21 passes through the first winding channel 54a from the dotted end in the second direction, and the non-dotted end (i.e. the second end) of the low-voltage winding W21 is electrically connected to an output positive terminal Vo+; drain of the synchronous rectification switch SR1 is electrically connected to the non-dotted end (i.e., the first end) of the low-voltage winding W22, the low-voltage winding W22 passes through the second winding channel 54b from the non-dotted end in the second direction, and the dotted end (i.e., the second end) of the low-voltage winding W22 is electrically connected to the output positive terminal Vo+. The first end of the low-voltage winding W21 and the first end of the low-voltage winding W22 are arranged on the first winding channel side 501a, the second end of the low-voltage winding W21 and the second end of the low-voltage winding W22 are arranged on the second winding channel side 501b, and the first winding group (i.e., the low-voltage winding W21 and the low-voltage winding W22) is wound clockwise from the dotted end of the low-voltage winding W21 to the non-dotted end of the low-voltage winding W22 for one turn in total around the first winding core leg 52a, that is, the low-voltage winding W21 is wound around the first winding core leg 52a for 0.5 turn, the low-voltage winding W22 is wound around the first winding core leg 52a for another 0.5 turn, and the first winding group is located on a same wiring layer of the winding substrate 10. The low-voltage winding W21 and the low-voltage winding W22 may also be formed on different wiring layers of the winding substrate 10 and short-circuited through a via which is also electrically connected to the output positive terminal Vo+. Similarly, the second switching circuit comprises a synchronous rectification switch SR3 and a synchronous rectification switch SR4; sources of the synchronous rectification switch SR3 and the synchronous rectification switch SR4 are electrically connected to output negative terminals Vo−; drain of the synchronous rectification switch SR4 is electrically connected to the dotted end (i.e., the first end) of the low-voltage winding W31, the low-voltage winding W31 passes through the second winding channel 54b from the dotted end in the first direction, and the non-dotted end (i.e., the second end) of the low-voltage winding W31 is electrically connected to an output positive terminal Vo+; drain of the synchronous rectification switch SR3 is electrically connected to the non-dotted end (i.e., the first end) of the low-voltage winding W32, the low-voltage winding W32 passes through the first winding channel 54a from the non-dotted end in the first direction, and the dotted end (i.e., the second end) of the low-voltage winding W32 is electrically connected to the output positive terminal Vo+. Therefore, the first end of the low-voltage winding W31 and the first end of the low-voltage winding W32 are arranged on the second winding channel side 501b, the second end of the low-voltage winding W31 and the second end of the low-voltage winding W32 are arranged on the first winding channel side 501a, and the second winding group (i.e., the low-voltage winding W31 and the low-voltage winding W32) is wound clockwise from the dotted end of the low-voltage winding W31 to the non-dotted end of the low-voltage winding W32 for one turn in total around the first winding core leg 52a, that is, the low-voltage winding W31 is wound around the first winding core leg 52a for 0.5 turn, and the low-voltage winding W32 is wound around the first winding core leg 52a for another 0.5 turn, and the second winding group is located on a same wiring layer of the winding substrate 10. The low-voltage winding W31 and the low-voltage winding W32 may also be formed on different wiring layers of the winding substrate 10 and short-circuited through a via which is also electrically connected to the output positive terminal Vo+.

The second circuit unit 8b comprises two switching circuits and two winding groups; the two switching circuits are respectively a third switching circuit and a fourth switching circuit; the third switching circuit comprises a synchronous rectification switch SR5 and a synchronous rectification switch SR6; sources of the synchronous rectification switch SR6 and the synchronous rectification switch SR5 are electrically connected to output negative terminals Vo−; drain of the synchronous rectification switch SR6 is electrically connected to the dotted end (i.e., the first end) of the low-voltage winding W51, the low-voltage winding W51 passes through the third winding channel 54c from the dotted end in the second direction, and the non-dotted end (i.e., the second end) of the low-voltage winding W51 is electrically connected to an output positive terminal Vo+; drain of the synchronous rectification switch SR5 is electrically connected to the non-dotted end (i.e., the first end) of the low-voltage winding W52, the low-voltage winding W52 passes through the fourth winding channel 54d from the non-dotted end in the second direction, and the dotted end (i.e., the second end) of the low-voltage winding W52 is electrically connected to the output positive terminal Vo+. Therefore, the first end of the low-voltage winding W51 and the first end of the low-voltage winding W52 are arranged on the first winding channel side 501a, the second end of the low-voltage winding W51 and the second end of the low-voltage winding W52 are arranged on the second winding channel side 501b, and the third winding group (ie, the low-voltage winding W51 and the low-voltage winding W52) is wound clockwise from the dotted end of the low-voltage winding W51 to the non-dotted end of the low-voltage winding W52 for one turn in total around the second winding core leg 52b, that is, the low-voltage winding W51 is wound around the second winding core leg 52b for 0.5 turn, the low-voltage winding W52 is wound around the second winding core leg 52b for another 0.5 turn, and the third winding group is located on the same wiring layer of the winding substrate 10. The low-voltage winding W51 and the low-voltage winding W52 may also be respectively formed on different wiring layers of the winding substrate 10 and short-circuited through a via which is also electrically connected to the output positive terminal Vo+. Similarly, the fourth switching circuit comprises a synchronous rectification switch SR7 and a synchronous rectification switch SR8; sources of the synchronous rectification switch SR7 and the synchronous rectification switch SR8 are electrically connected to output negative terminals Vo−; drain of the synchronous rectification switch SR8 is electrically connected to the dotted end (i.e., the first end) of the low-voltage winding W61, the low-voltage winding W61 passes through the fourth winding channel 54d from the dotted end in a first direction, and the non-dotted end (i.e., the second end) of the low-voltage winding W61 is electrically connected to an output positive terminal Vo+; drain of the synchronous rectification switch SR7 is electrically connected to the non-dotted end (i.e., the first end) of the low-voltage winding W62, the low-voltage winding W62 passes through the third winding channel 54c from the non-dotted end in the first direction, and the dotted end (i.e., the second end) of the low-voltage winding W62 is electrically connected to the output positive terminal Vo+. Therefore, the first end of the low-voltage winding W61 and the first end of the low-voltage winding W62 are arranged on the second winding channel side 501b, the second end of the low-voltage winding W61 and the second end of the low-voltage winding W62 are arranged on the first winding channel side 501a, and the fourth winding group (ie, the low-voltage winding W61 and the low-voltage winding W62) is wound clockwise from the dotted end of the low-voltage winding W61 to the non-dotted end of the low-voltage winding W62 for one turn in total around the second winding core leg 52b, that is, the low-voltage winding W61 is wound around the second winding core leg 52b for 0.5 turn, the low-voltage winding W62 is wound around the second winding core leg 52b for another 0.5 turn, and the fourth winding group is located on the same wiring layer of the winding substrate 10. The low voltage winding W61 and the low voltage winding W62 may also be formed on different wiring layers of the winding substrate 10 and short-circuited through a via which is also electrically connected to the output positive terminal Vo+. At least four output capacitors Co are respectively arranged on two opposite sides of the magnetically permeable core 5a, that is, on the first winding channel side 501a and on the second winding channel side 501b, and are bridged between the output positive terminal Vo+ and the output negative terminal Vo− of each side. The output positive terminals Vo+ on the two opposite sides of the magnetically permeable core 5a are short-circuited, and the output negative terminals Vo− on the two sides of the magnetically permeable core 5a are short-circuited. The winding arrangement and device layout shown in FIG. 5B are similar to those of FIG. 2D, the beneficial effects shown in winding arrangement according to FIG. 2D are also shown herein, and details are not described again.

Referring to FIG. 4A and FIG. 4B, each circuit unit 8a/b corresponds to a set of control signal groups, wherein the first circuit unit 8a corresponds to a first control signal group (i.e., the control signals PWM1-PWM4), and the second circuit unit 8b corresponds to a second control signal group (i.e., the control signals PWM5-PWM8); the control signal PWM1 in the first control signal group and the control signal PWM5 in the second control signal group are in a phase offset of 90 degrees; with the control signals PWM2-PWM4 specified according to the control signal PWM1 and the control signals PWM6-PWM8 specified likewise according to the control signal PWM5, the control signal in the first control signal group and the corresponding control signal in the second control signal group are in a phase offset of 90 degrees; the AC magnetic fluxes flowing through the winding core leg 52a and the winding core leg 52b are clamped by the volt-second of the two high-voltage windings. For example, the AC magnetic flux flowing through the first winding core leg 52a is ahead of the AC magnetic flux flowing through the second winding core leg 52b by 90 degrees in phase, and as shown in FIG. 5D, the upper chart is the variation trend of AC magnetic flux Φ1 flowing through the first winding core leg 52a over time, and the middle chart is the variation trend of AC magnetic flux Φ2 flowing through the second winding core leg 52b over time. Referring to FIG. 5C, AC magnetic flux flowing through the channel wall 55a and the first side core leg 51a is determined by the volt-second of the low-voltage winding W21 or W32, thus proportional to the magnetic flux Φ1 and the amplitude halved; AC magnetic flux flowing through the channel wall 55b is determined by the volt-second of the low-voltage winding W22 or W31, proportional to the magnetic flux Φ1 and the amplitude halved; AC magnetic flux flowing through the channel wall 55c is determined by the volt-second of the low-voltage winding W51 or W62, proportional to the magnetic flux Φ2 and the amplitude halved; AC magnetic flux flowing through the channel wall 55d and the second side core leg 51b is determined by the volt-second of the low-voltage winding W52 or W61, proportional to the magnetic flux Φ2 and the amplitude halved. The variation trend of AC magnetic flux Φ3 flowing through the public core leg 53 over time is shown in the lower chart. The AC magnetic flux flowing through the channel wall 55b and the AC magnetic flux flowing through the channel wall 55c are superposed on the public core leg 53, and the amplitude of the magnetic flux Φ3 is half of the amplitude of the magnetic flux Φ1 or the magnetic flux Φ2. The variation trend in a switching period (i.e., interval 0-t4) is shown in FIG. 5D. In the interval 0-t1, the magnetic flux Φ3 keeps a minimum value unchanged; in the interval t1-t2, the magnetic flux Φ3 increases from the minimum value to a maximum value; in the interval t2-t3, the magnetic flux Φ3 keeps the maximum value unchanged; and in the interval t3-t4, the magnetic flux Φ3 decreases from the maximum value to the minimum value; the waveform repeats. Since the AC magnetic flux flowing through each of the first side core leg 51a, the second side core leg 51b, the public core leg 53 and the channel walls 55a/b/c/d is half of the AC magnetic flux flowing through the first winding core leg 52a or the second winding core leg 52b, and the cross sectional area of each of the first side core leg 51a, the second side core leg 51b, the public core leg 53 and the channel walls 55a/b/c/d is configured to be half of the cross sectional area of the first winding core leg 51a or the second winding core leg 52b, the AC magnetic flux density at any position within the magnetically permeable core 5a is approximately equal, the energy loss of the magnetically permeable core 5a is reduced, and the utilization rate of the magnetically permeable core 5a is improved. For another example, the AC magnetic flux flowing through the first winding core leg 52a lags the AC magnetic flux flowing through the second winding core leg 52b by 90 degrees in phase, and as shown in FIG. 5E, variation trend of the AC magnetic flux Φ3 flowing through the public core leg 53 over time is shown in the lower chart of FIG. 5E. Compared with the AC magnetic flux Φ3 shown in FIG. 5D, the AC magnetic flux Φ3 shown in FIG. 5E is similar in waveform, the same in amplitude, and advanced by 90 degrees in phase.

According to FIG. 5C, further, an air gap 56a and an air gap 56b are respectively provided at the first winding core leg 52a and the second winding core leg 52b for increasing the reluctance of the first winding core leg 52a and the second winding core leg 52b, and the heights of the two air gaps are approximately equal, so that magnetization current is generated in each high-voltage winding for ZVS turn-on in the high-voltage circuit respectively electrically connected. The first side core leg 51a, the second side core leg 51b and the public core leg 53 are not provided with air gaps in some embodiments; alternatively in some other embodiments, they are respectively provided with air gaps which are approximately equal in height, and the heights are smaller than those of the air gap 56a and the air gap 56b; alternatively in some other embodiments, air gaps are provided at the first side core leg 51a, the second side core leg 51b and the public core leg 53 and the air gaps at all of the five core legs are equal in height, so that on one hand, due to the fact of the same in height, the processing steps on the first winding core leg 52a and the second winding core leg 52b for setting the height of the air gaps are reduced, and the magnetically permeable core 5a is easy to from and assemble; on the other hand, the air gaps of the first winding core leg 52a and the second winding core leg 52b are shortened, and the air gaps of the first side core leg 51a, the second side core leg 51b and the public core leg 53 are increased, so that the total amount of eddy current loss generated on the windings by the magnetic flux leakage from the air gaps at the five core legs is reduced, the light-load power loss of the power module B is reduced, and the heavy-load conversion efficiency of the power module B is improved.

The integration of two transformers into a five-leg magnetically permeable core in the two circuit units improves the integration level of the magnetically permeable core; the size of the magnetically permeable core is reduced, and the size of the power module B is consequently reduced.

The three-dimensional structure schematic diagram of the power module B is shown in FIGS. 6A-6C. With reference to the explosion schematic diagram shown in FIG. 6C, five core legs of the magnetically permeable core 5a penetrate respectively through five parallel magnetically-permeable-core holes 103, which match the core legs in number and shape and formed in the winding substrate 10, and two core sections cover the first surface 101 and the second surface 102 of the winding substrate 10 to form closed magnetic circuits. The structure of the magnetically permeable core 5a is not limited to an assembly of two E-shaped cores sections as shown in the figure, and may also be an assembly of an I-shaped core section and an E-shaped core section; alternatively in some embodiments, the two core plates and the five core legs are individual core sections. After the magnetically permeable core 5b is assembled with the substrate, the region in the winding substrate 10 between each two adjacent magnetically-permeable-core holes 103 correspond to one winding channel, and the winding channels are respectively referred to as a first winding channel 54a, a second winding channel 54b, a third winding channel 54c and a fourth winding channel 54d; two opposite side surfaces of the magnetically permeable core 5a according to the terminals of the four winding channels are respectively referred to as a first winding channel side 501a and a second winding channel side 501b. The synchronous rectification switches SR are equally arranged on the first and second surfaces 101/102 of the winding substrate 10; and on the first surface 101, the synchronous rectification switches SR is further equally arranged on the first and second winding channel sides 501a/b. The first switching circuit and the third switching circuit are arranged on the first winding channel side 501a, the second switching circuit and the fourth switching circuit are arranged on the second winding channel side 501b. The synchronous rectification switches SR located on the same winding channel side on each surface of the winding substrate 10 is arranged along a switch position line, the switch position line is defined as a straight line penetrating through all synchronous rectification switches SR on the same surface and on the same winding channel side, and the switch position line is approximately perpendicular to the direction through the winding channels; the arrangement of the synchronous rectification switches SR on the second surface 102 is similar to those on the first surface 101, and details are not described herein again; in addition, the synchronous rectification switches SR on the first surface 101 are in one-to-one correspondence to those on the second surface 102, forming a plurality of synchronous rectification switch pairs. The projections of the two synchronous rectification switches in each synchronous rectification switch pair to the first surface 101 partially overlap or wholly coincide with each other, so that the drains or the sources of the two synchronous rectification switches in each synchronous rectification switch pair may be short-circuited by a vertical via through the winding substrate 10 just at the position of the bonding pads of the synchronous rectification switches as well as other kind of via. The output capacitors Co are divided into two groups which are respectively arranged on the outer side of the synchronous rectification switches SR. In each group, the output capacitors are further arranged on the first surface 101 and the second surface 102 in pairs, and the projections of the output capacitors Co in each pair to the first surface 101 partially overlap or wholly coincide with each other, so that the output capacitors on the first and second surfaces 101/102 may be electrically connected in parallel by vertical vias through the substrate 10 just at the positions of the bonding pads as well as other kinds of vias. The output capacitors Co are evenly distributed on the outer side of the synchronous rectification switches, so that the drains of the synchronous rectification switches in each switching circuit are connected to the first end of the corresponding low-voltage winding at a shortest distance, the sources of the synchronous rectification switch in each switching circuit are adjacent to each other; the alternating current loop formed by each switching circuit and the corresponding winding electrically connected is minimized. Therefore, the parasitic leakage inductance of the loop and the alternating current resistance of the loop are greatly reduced, the loss of the power module B is reduced, and the efficiency is improved. The output pins 30 are placed on the second surface 102 of the winding substrate 10, divided into two groups, and arranged on the outer side of the synchronous rectification switch group. The output pins 30 may be arranged on the outer side of the arrangement region of the output capacitors Co, or between the arrangement regions of the output capacitors Co and the synchronous rectification switch group, or within the arrangement region of the output capacitors Co, as shown in FIG. 6B; output pins 30 in each group is arranged along an output pin position line, and the output pin position line is defined as a straight line penetrating through at least three output pins in the same group. In some embodiments, the output pin position line penetrates through all the output pins in the same group, and the output pin position line is approximately perpendicular to the direction through the winding channels. According to the arrangement of the output pins 30, the output pins may be respectively arranged adjacent to the switching circuits on the two sides of the winding channel, the parasitic resistance from the switching circuit to the output pin is greatly reduced, and the loss caused by the parasitic resistance is reduced. In some embodiments, the input pins 20 are also divided into two groups which are respectively arranged on the outer side of the synchronous rectification switch group, and each group of input pins 20 and a corresponding group of output pins 30 on the same side are arranged side by side; the arrangement of the input pins 20 is not limited thereto.

In other words, as shown in FIG. 6D, the area on the second surface 102 of the winding substrate 10 is divided into a first output region 91a, a first switch region 92a, a core assembly region 93, a second switch region 92b and a second output region 91b. The first output region 91a, the first switch region 92a, the core assembly region 93, the second switch region 92b and the second output region 91b are sequentially arranged in the same direction. With reference to FIG. 6B, some or all of the components of the magnetic apparatus 3 are arranged within the magnetic assembly region 93, some of the switching circuits of the power module B are arranged within the first switch region 92a, and others of the switching circuits are arranged within the second switch region 92b. In some embodiments, the switch SR1 in the first switching circuit, the switch SR2 in the first switching circuit, the switch SR5 in the third switching circuit and the switch SR6 in the third switching circuit are all arranged within the first switch region 92a, the switch SR3 in the second switching circuit, the switch SR4 in the second switching circuit, the switch SR7 in the fourth switching circuit, and the switch SR8 in the fourth switching circuit are arranged within the second switch region 92b. In some embodiments, one group of output pins and one group of output capacitors Co are arranged within the first output region 91a, and another group of output pins 30 and another group of output capacitors Co are arranged within the second output region 91b; the layout of the first output region and the second output region are not limited to those shown in FIG. 6B and FIG. 6D. In some embodiments, only output pins 30 are arranged within the first and second output regions; in some other embodiments, only output capacitors Co are arranged within the first and second output regions.

On one side of the second surface of the power module B in some embodiments, a first group of output pins, the first switching circuit, the magnetically permeable core, the second switching circuit and a second group of output pins are sequentially arranged in the same direction; in some other embodiments, a first group of output capacitors, the first switching circuit, the magnetically permeable core, the second switching circuit and a second group of output capacitors are sequentially arranged in the same direction; alternatively in some other embodiments, a first group of output pins, a first group of output capacitors, the first switching circuit, the magnetic permeable core, the second switching circuit, a second group of output capacitors and a second group of output pins are sequentially arranged in the same direction. Three layouts of devices all show the described beneficial effects. In addition, the power module A according to FIGS. 3A-3C may also be provided with a similar layout.

### Embodiment 3

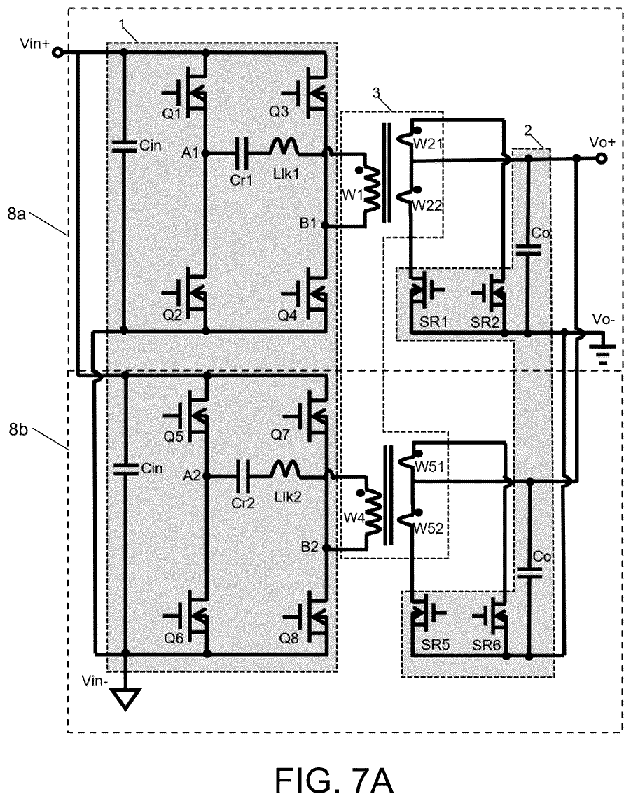

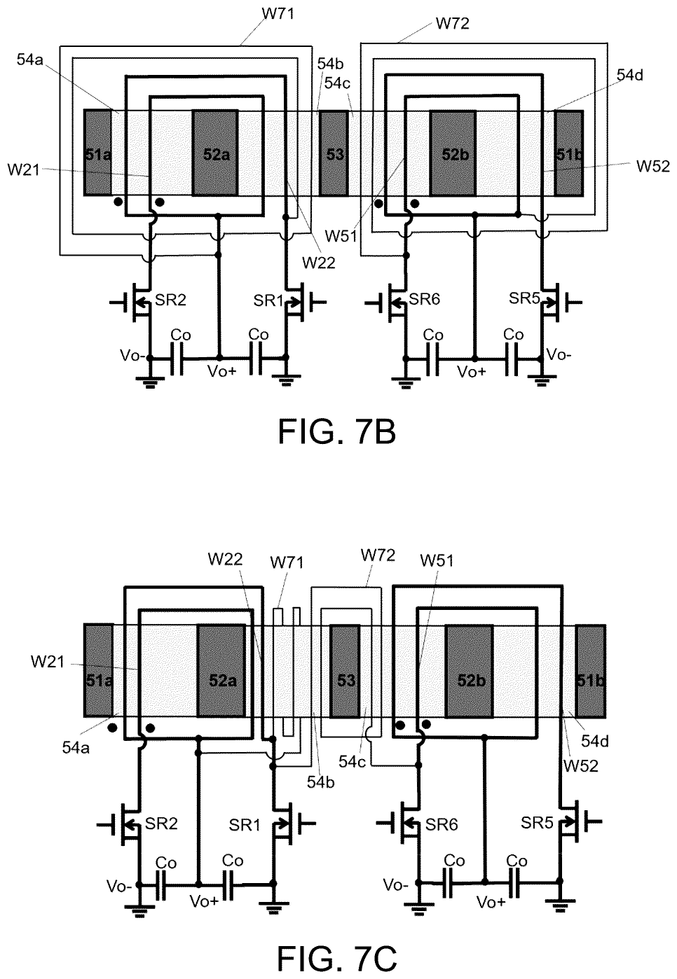

FIGS. 7A-7C show a circuit topology schematic diagram of Embodiment 3, a structure of a magnetic apparatus, and a corresponding winding method. The circuit topology diagram shown in FIG. 7A comprises two circuit units, but is different from the circuit topology schematic diagram shown in FIG. 4A, the circuit topology shown in FIG. 7A comprises a first circuit unit 8a and a second circuit unit 8b, the second circuit unit 8b only comprises a third winding group (i.e., the low-voltage winding W51 and the low-voltage winding W52) and a second switching circuit (i.e., the synchronous rectification switch SR5 and the synchronous rectification switch SR6), and the number of turns of the low-voltage winding in each circuit unit is changed from 0.5 turn to one turn. The two transformers shown in FIG. 7A are also integrated in a five-leg magnetically permeable core 3, high-voltage windings are wound on the two winding core legs of the five-leg magnetically permeable core respectively, the winding method of the high-voltage winding is similar to that of FIG. 5A, and details are not repeated here; the winding method of the low-voltage winding and the position and connection relationship of the synchronous rectification switch are as shown in FIG. 7B or FIG. 7C, the first switching circuit of the first circuit unit 8a comprises two synchronous rectification switches SR1 and a synchronous rectification switch SR2, and after the sources of the synchronous rectification switch SR1 and the synchronous rectification switch SR2 are short-circuited, the synchronous rectification switch SR1 and the synchronous rectification switch SR2 are connected to the output negative terminal Vo− (i.e., the negative voltage terminal of the output capacitor Co), the drain of the synchronous rectification switch SR2 is electrically connected to the first end (i.e., the dotted end) of the low-voltage winding W21, the drain of the synchronous rectification switch SR1 is electrically connected to the first end (i.e., the non-dotted end) of the low-voltage winding W22, and the second end of the W22 of the low-voltage winding and the second end of the low-voltage winding W21 are electrically connected to an output positive terminal Vo+(i.e., the positive voltage terminal of an output capacitor Co), the low-voltage winding W21 passes through the first winding channel 54a in a second direction (such as from bottom to top) from the dotted end to the non-dotted end, and then passes through the second winding channel 54b in a first direction (such as from top to bottom); the low-voltage winding W22 passes through the second winding channel 54b from the non-dotted end to the dotted end in the second direction and then passes through the first winding channel 54a in the first direction; therefore, the first winding is combined from the dotted end of the low-voltage winding W21 to the non-dotted end of the low-voltage winding W22 clockwise around the first winding core leg 52a for two turns, that is, the low-voltage winding W21 is wound around the first winding core leg 52a for one turn, and the low-voltage winding W22 is wound around the first winding core leg 52a for one turn. The second switching circuit of the second circuit unit comprises two synchronous rectification switches SR5 and SR6, and the sources of the synchronous rectification switches SR5 and SR6 are short-circuited and then connected to the output negative terminal Vo− (i.e., the negative voltage terminal of the output capacitor Co), the drain of the synchronous rectification switch SR6 is electrically connected to the first end (i.e., the dotted end) of the low-voltage winding W51; the drain of the synchronous rectification switch SR5 is electrically connected to the first end (i.e., the non-dotted end) of the low-voltage winding W52; the second end of the low-voltage winding W52 and the second end of the low-voltage winding W51 are electrically connected to an output positive terminal Vo+(i.e., a positive voltage terminal of an output capacitor Co); the low-voltage winding W52 passes through the fourth winding channel 54d from the non-dotted end to the dotted end in the second direction, and then passes through the third winding channel 54c in the first direction; therefore, the third winding is combined from the dotted end of the low-voltage winding W51 to the non-dotted end of the low-voltage winding W52 to be wound clockwise around the second winding core leg 52b for two turns, that is, the low-voltage winding W51 is wound around the second winding core leg 52b for one turn, and the low-voltage winding W52 is wound around the second winding core leg 52b for one turn. In some embodiments, the first end and the second end of each low-voltage winding extends out of the same winding channel side, the switches SR1/SR2/SR5/SR6 are all arranged on the same winding channel side (i.e., the first winding channel side 501a).

The magnetic apparatus further comprises an additional winding 71 and an additional winding 72; one end of the additional winding 71 is electrically connected with the drain of the switch SR1, the other end of the additional winding 71 is electrically connected with the output positive terminal Vo+, the additional winding 71 passes through the second winding channel 54b in the same direction twice and is wound anticlockwise around the first side core leg 51a and the first winding core leg 52a as a whole, so that the variation trend of the AC magnetic flux flowing through the first side core leg 51a and the channel wall 55b over time is controlled by the volt-second of the two ends of the additional winding 71; in addition, the additional winding 71 is equivalent to being connected in parallel with the low-voltage winding W22, so that the AC magnetic flux flowing through the first side core leg 51a is opposite in direction and half in amplitude compared with the AC magnetic flux flowing through the first winding core leg 52a; furthermore, since the AC magnetic flux flowing through the first side core leg 51a and the AC magnetic flux flowing through the channel wall 55b are superposed and flow into the first winding post 52a, the amplitude of the AC magnetic flux flowing through the first side post 51a is equal to the amplitude of the AC magnetic flux flowing through the channel wall 55b. Similarly, one end of the additional winding 72 is electrically connected with the drain of the switch SR6, the other end of the additional winding 72 is electrically connected with the output positive terminal Vo+, the additional winding 72 passes through the third winding channel 54c in the same direction twice and is wound clockwise around the second side core leg 51b and the second winding core leg 52b as a whole, so that the variation trend of the AC magnetic flux flowing through the second side core leg 51b and the channel wall 55c over time is controlled by the volt-second of the two ends of the additional winding 72; in addition, the additional winding 72 is equivalent to being connected in parallel with the low-voltage winding W52, so that the AC magnetic flux flowing through the second side core leg 51b is opposite in direction and half in amplitude compared with the AC magnetic flux flowing through the second winding core leg 52b; furthermore, since the AC magnetic flux flowing through the second side core leg 51b and the AC magnetic flux flowing through the channel wall 55c are superposed and flow into the second winding core leg 52b, the amplitude of the AC magnetic flux flowing through the second side core leg 51b is equal to the amplitude of the AC magnetic flux flowing through the channel wall 55c; the variation trend of the AC magnetic flux flowing through the public core leg 53 over time is equal to that of the superposition of the AC magnetic flux flowing through the channel walls 55b and 55c. By providing the additional winding 71 and the additional winding 72, the AC magnetic flux flowing through the first side core leg 51a or the second side core leg 51b or the public core leg 53 or each channel wall 55a/b/c/d is configured steadily to be half in amplitude of the AC magnetic flux flowing through the winding core leg 52a or the winding core leg 52b, while the corresponding cross-sectional area is also configured to be half of the cross-sectional area of the winding core leg 52a or the winding core leg 52b, so that the AC magnetic flux density at any position within the magnetically permeable core is approximately equal, the loss of the magnetically permeable core is reduced, the utilization rate of the magnetically permeable core is improved, and the size of the magnetically permeable core is further reduced.

In the aforementioned description, two switching circuits are provided for example, and the synchronous rectification switches are arranged on the same winding channel side. The implementation of the additional windings in the winding arrangement is not limited thereto, and in some other embodiments four winding groups and four switching circuits is provided as shown in FIG. 4A, and synchronous rectification switches in two switching groups are arranged on the other winding channel side (i.e., the second winding channel side 502b), so that all the synchronous rectification switches are evenly arranged on the two winding channel sides.

The winding arrangement of the additional windings 71 and 72 is not limited to the winding arrangement shown in FIG. 7B. In some embodiments, as shown in FIG. 7C, the additional winding 71 is wound in the same direction around the channel wall 55b of any core plate 50 for two turns, so that the same technical effect as that of the additional winding 71 shown in FIG. 7B is obtained, that is, the AC magnetic flux flowing through the channel wall 55b is configured to be half in amplitude of the AC magnetic flux flowing through the first winding core leg 52a, resulting that the AC magnetic flux flowing through the first side core leg 51a is opposite in direction and half in amplitude compared with the AC magnetic flux flowing through the first winding core leg 52a; one end of the additional winding 72 is connected with the drain of the synchronous rectification switch SR1, the other end of the additional winding 72 is connected with the drain of the adjacent synchronous rectification switch SR6, and the additional winding 72 is wound around the public core leg 53 clockwise for two turns, so that the AC magnetic flux flowing through the public core leg 53 is configured to be proportional in variation trend over time and half in amplitude compared with the superposition of the AC magnetic fluxes flowing through the first winding core leg 52a and the second winding core leg 52b, resulting that the AC magnetic flux flowing through the channel wall 55c is half in amplitude of the AC magnetic flux flowing through the second winding core leg 52b, and the AC magnetic flux flowing through the second side core leg 51b is opposite in direction and half in amplitude compared with the AC magnetic flux flowing through the second winding core leg 52b. According to the winding arrangement of the additional winding 71 and the additional winding 72 shown in FIC. 7C, the technical effects of the winding arrangement as shown in FIG. 7B is obtained.

### Embodiment 4

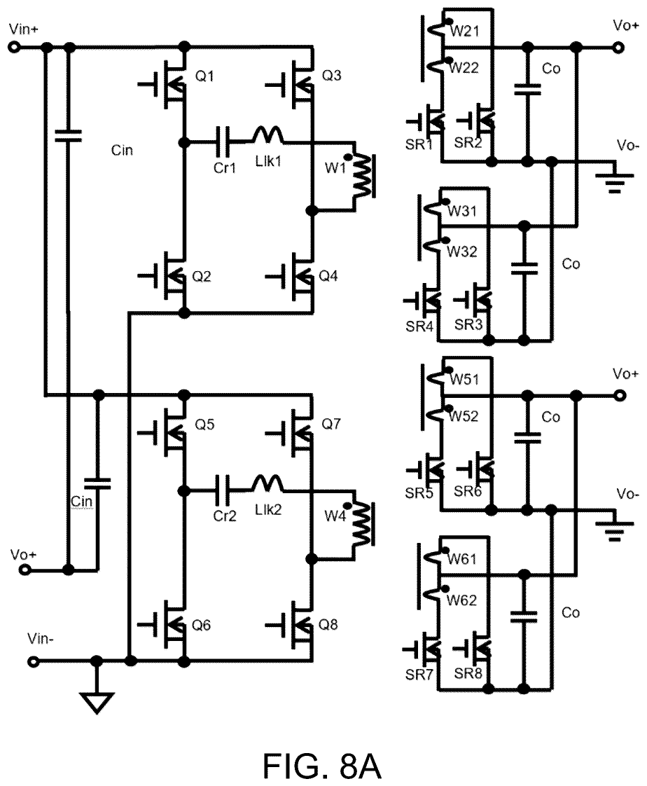

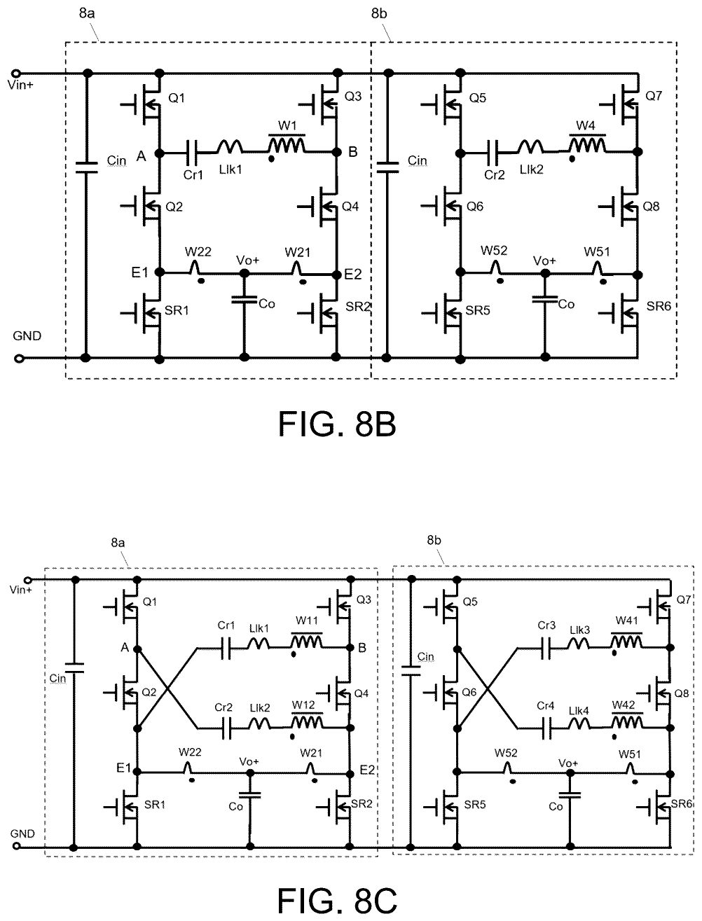

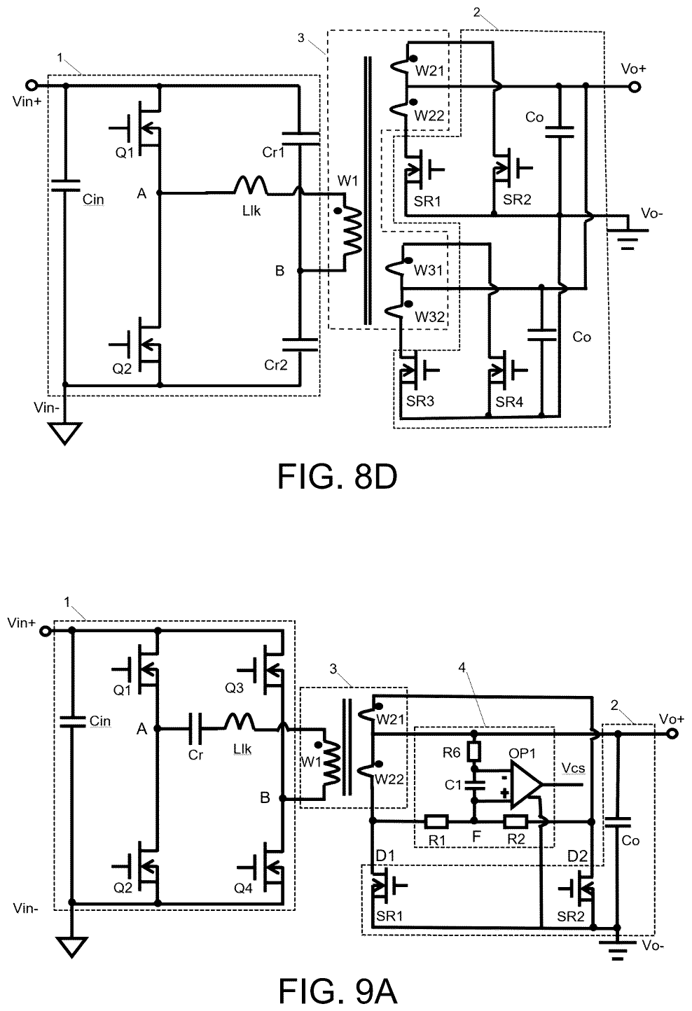

FIG. 8A shows a schematic circuit topology in some embodiments, which is a substitution for the circuit topology shown in FIG. 4A. The negative voltage terminal of the input capacitor is electrically connected to the output positive terminal Vo+ instead of being electrically connected to the input negative terminal Vin−, so that one part of the output current ripples generated by the eight low-voltage windings flows into the output capacitor Co, and the other part flows into the input capacitor Cin, and is sent to the bridge arms of the high-voltage circuit 1 through the input capacitor Cin, so that the current ripples flowing into the output capacitor Co is reduced, the capacitance of the output capacitor Co or the number of output capacitors Co may be reduced, and the size of the power module is further reduced. Other technical features may be configured according to the embodiments described above, and details are not repeated; the connection arrangement of the input capacitor described herein may be implemented in other embodiments.

### Embodiment 5

FIG. 8B shows a schematic circuit topology in some embodiments, which is a substitution for the circuit topology shown in FIG. 7A, comprising two identical circuit units 8a and 8b. The circuit units 8a/b have the same circuit topology and are electrically connected in parallel. Each circuit unit at least comprises two bridge arms, a switching circuit, and a transformer unit. In the first circuit unit 8a, the transformer unit comprises a high voltage winding W1 and a first winding group, wherein the first winding group comprises a low voltage winding W21 and a low voltage winding W22; the high-voltage switch Q1 and the high-voltage switch Q2 are electrically connected in series to form a bridge arm, the high-voltage switch Q3 and the high-voltage switch Q4 are electrically connected in series to form the other half bridge arm; the middle nodes of the two bridge arms are referred to as a middle node A and a middle node B; the first switching circuit comprises a synchronous rectification switch SR1 and a synchronous rectification switch SR2, the sources of the switches SR1 and SR2 are electrically connected to the output negative terminal Vo−. One end of each bridge arm is electrically connected to the input positive terminal Vin+, the other end of each bridge arm is electrically connected with the drain of the corresponding synchronous rectification switch, and the two electrical connection nodes are referred to as an electrical connection node E1 and an electrical connection node E2 respectively; the electrical connection node E1 is between a source of the high-voltage switch Q2 and a drain of the synchronous rectification switch SR1; and the electrical connection node E2 is between a source of the high-voltage switch Q4 and a drain of the synchronous rectification switch SR2. The high-voltage winding W1, the equivalent resonant inductor Llk1 and the resonant capacitor Cr1 are connected in series between the middle node A and the middle node B; the second end of the low-voltage winding W21 and the second end of the low-voltage winding W22 are electrically connected to the output positive terminal Vo+; the first end of the low-voltage winding W21 is electrically connected to the node E1, and the first end of the low-voltage winding W22 is electrically connected to the node E2. Each circuit unit is controlled by a set of control signals including a first control signal and a second control signal; the high-voltage switch Q1, the high-voltage switch Q4 and the synchronous rectification switch SR1 are controlled by the first control signal, switched on or switched off at the same time; the duty ratio of the first control signal is close to 50%; the high-voltage switch Q3 and the high-voltage switch Q2 and the synchronous rectification switch SR2 are controlled by the second control signal, switched on or switched off at the same time; the duty ratio of the second control signal is close to 50%. With the dead time between the two control signals ignored, the first control signal and the second control signal are considered as complement to each other (i.e., they are 180 degrees out of phase). The second circuit unit 8b comprises two bridge arms, a second switching circuit and a transformer unit. The second switching circuit comprises a synchronous rectification switch SR5 and a synchronous rectification switch SR6. The transformer unit comprises a high-voltage winding W4 and a third winding group, wherein the third winding group comprises a low-voltage winding W51 and a low-voltage winding W52, and the technical features thereof may refer to the first circuit unit 8a. In some embodiments, the two transformer units include two discrete magnetically permeable cores, and in some other embodiments a five-leg magnetically permeable core is provided. The high-voltage winding W1, the low-voltage winding W21 and the low-voltage winding W22 are coupled to the same winding core leg to form one transformer unit, and an additional inductor or parasitic leakage inductance of the transformer unit may be provided as the equivalent resonant inductor Llk1; the high-voltage winding W4 and the low-voltage winding W51 and the low-voltage winding W52 are coupled to the other winding core leg to form another transformer unit, and an additional inductor or parasitic leakage inductance of the transformer unit may be provided as the resonant inductor Llk2. The two transformer units may be arranged in a same five-leg magnetically permeable core as shown in FIGS. 5A-5C, and the arrangements and the electrical connections of the low-voltage windings and the switching circuits may refer to the above embodiments for same technical effects.

The two circuit units are controlled in a same way, with the corresponding control signals configured to have a phase offset of 90 degrees. For example, the first control signal for controlling the high-voltage switch Q1 is ahead of or lags the first control signal for controlling the high-voltage switch Q5 by 90 degrees in phase, and the second control signal of the high-voltage switch Q3 is correspondingly ahead of or correspondingly lags the second control signal for controlling the high-voltage switch Q7 by 90 degrees in phase. The described configuration of the circuit units and the corresponding control signals meets the requirements of different input and output voltage gain ratios. Each circuit unit may further include at least one input capacitor Cin and at least one output capacitor Co, as shown in FIG. 8B. The control signals of the aforementioned two circuit units are 90 degrees out of phase with each other, and advantages are obtained that the capacitances of the output capacitors Co and the input capacitors Cin in the power module are greatly reduced. The equivalent total capacitance of the output capacitor Co of the power module may be smaller than not only N×K×K times of the equivalent capacitance of the resonant capacitor Cr1 or Cr2 (N is the number of circuit units, i.e., N is equal to 2 here; K is the input and output voltage gain ratio, namely K=Vin/Vo), but also 0.5×N×K×K times or even 0.25×N×K×K times of equivalent capacitance of the resonant capacitor Cr1 or Cr2. The equivalent total capacitance of the input capacitor Cin may be smaller than not only N times of the equivalent capacitance of the resonant capacitor Cr1 or Cr2, but also 0.5×N times or even 0.25×N times of the equivalent capacitance of the resonant capacitor Cr1 or Cr2.

### Embodiment 6

FIG. 8C discloses a schematic circuit topology diagram in some embodiments, which is a six-switch-per-unit resonant circuit topology, and two circuit units are provided and electrically connected in parallel, which is similar to the embodiments according to FIG. 8B. The difference is that the magnetic apparatus of each circuit unit comprises two high-voltage windings, which are referred to as a high-voltage winding W11 and a high-voltage winding W12 in one circuit unit and a high-voltage winding W41 and a high-voltage winding W42 in another circuit unit; the connection topology of the high-voltage windings in the first circuit unit 8a is described in the following for example. The high-voltage winding W11 is connected in series with the equivalent resonance inductor Llk1 and the resonance capacitor CR1 to form a resonance branch which is bridged between the middle node A of the bridge arm and the electrical connection node E2, and the high-voltage winding W12 is connected in series with the equivalent resonant inductor Llk2 and the resonant capacitor Cr2 to form another resonance branch which is bridged between the middle node B of the bridge arm and the electrical connection node E1. That is, the two resonance branches are cross-connected across the middle nodes of the two bridge arms and the electrical connection nodes of the bridge arms and the low-voltage circuits; one end of each resonance branch is electrically connected with the middle node of one bridge arm, and the other end of each resonance branch is electrically connected with the electrical connection node of the other bridge arm and the low-voltage circuit. The high-voltage winding W11 and the high-voltage winding W12 and the low-voltage winding W21 and the low-voltage winding W22 in the first winding group are coupled to a same core leg to form a transformer unit, additional inductors or parasitic leakage inductance of the transformer unit may be provided as the equivalent resonant inductors Llk1/Llk2. Similarly, the high-voltage winding W41 and the high-voltage winding W42 and the low-voltage winding W51 and the low-voltage winding W52 in the third winding group are coupled to a same core leg to form a transformer unit, additional inductors or parasitic leakage inductance of the transformer unit may be provided as the equivalent resonant inductors Llk3/Llk4; in some embodiments the two transformer units include two discrete magnetically permeable cores, and in some other embodiments a five-leg magnetically permeable core is provided (as shown in FIGS. 5A to 5C). Two circuit units are controlled in a same way, with the corresponding control signals configured to have a phase offset of 90 degrees. By adjusting the ratio of the number of turns of the high-voltage winding to the number of turns of the low-voltage winding, the described configuration meets the requirements of different input and output voltage gain ratios. In some embodiments, the input and output voltage gain ratio K is equal to 4:1, high-voltage windings are not provided in each circuit unit, and only the equivalent resonant inductors and the resonant capacitors are reserved and electrically connected in series across the corresponding nodes. Each circuit unit may further include at least one input capacitor Cin and at least one output capacitor Co, as shown in FIG. 8C. The control signals of the aforementioned two circuit units are 90 degrees out of phase with each other, and advantages are obtained that the capacitances of the output capacitors Co and the input capacitors Cin in the power module are greatly reduced. The equivalent total capacitance of the output capacitors Co of the power module may be smaller than N× K×K times of the equivalent total capacitance Cr of the resonant capacitors (Cr is equal to Cr1+Cr2 or Cr3+Cr4; N is the number of circuit units, i.e., N is equal to 2 here; K is the input and output voltage gain ratio, namely K=Vin/Vo), and may even be smaller than 0.5×N×K×K times or 0.25×N×K×K times of the equivalent total capacitance Cr of the resonant capacitors. The equivalent total capacitance of the input capacitors Cin may be smaller than not only N times of the equivalent total capacitance Cr of the resonant capacitors, but also 0.5×N times or even 0.25×N times of the equivalent total capacitance Cr of the resonant capacitors.

### Embodiment 7

FIG. 8D is a schematic circuit topology diagram in some embodiments, different from the circuit topology shown in FIG. 1A. The resonant capacitor Cr1 and the resonant capacitor Cr2 are connected in series to form a second bridge arm of capacitors; the second bridge arm is connected in parallel with a first bridge arm of switches; the equivalent resonant inductor Llk and the high-voltage winding W1 in the magnetic apparatus are connected in series to form an LL resonance branch; the LL resonance branch is bridged between the middle node of the first bridge arm and the middle node of the second bridge arm. Through the switching of the high-voltage switch Q1 and the high-voltage switch Q2, the resonant capacitor CR1 or the resonant capacitor CR2 resonates with the equivalent resonant inductor Llk respectively; other technical features are the same as the embodiments shown in FIG. 1A, and the circuit topology described herein may be implemented to the above embodiments.

The switches in the above embodiment are illustrated as Si MOSFET for example, and may also be other kind of switches such as SiC MOSFET, GaN MOSFET, or IGBT MOSFET. The electrical connections of the switches may be correspondingly locally adjusted according to different switch types. The circuit topology shown in the above embodiment may be implemented as a bidirectional converter, that is, the output terminals connected with the low-voltage circuit is changed into input terminals, the input terminals connected with the high-voltage circuit is changed into output terminals, and the corresponding technical features and the beneficial effects are the same; when the high-voltage side serves as input and the voltage between the high-voltage input terminals is Vin, and the low-voltage side serves as output and the voltage between the low-voltage output terminals is Vo, the ratio of the conversion device described as the voltage of the high-voltage side over the voltage of the low-voltage side is K=Vin/Vo; when the high-voltage side serves as output and the voltage between the high-voltage output terminals is Vo, the low-voltage side serves as input and the voltage between the low-voltage input terminals is Vin, the ratio of the conversion device described as a high-over-low voltage ratio is K=Vo/Vin. The phrases “equal” or “same” or “equal to” disclosed by the application needs to consider the parameter distribution of engineering, and the error distribution is within ±30%; the geometric description “paralell” is defined as the included angle between the two line segments or the two straight lines is smaller than or equal to 45 degrees; the geometric description “perpendicular” is defined as the angle between the two line segments or the two straight lines is within the range of [60, 120]; the definition of phase offsets also needs to consider the parameter distribution of engineering, and the error distribution is within ±30%.

### Embodiment 8

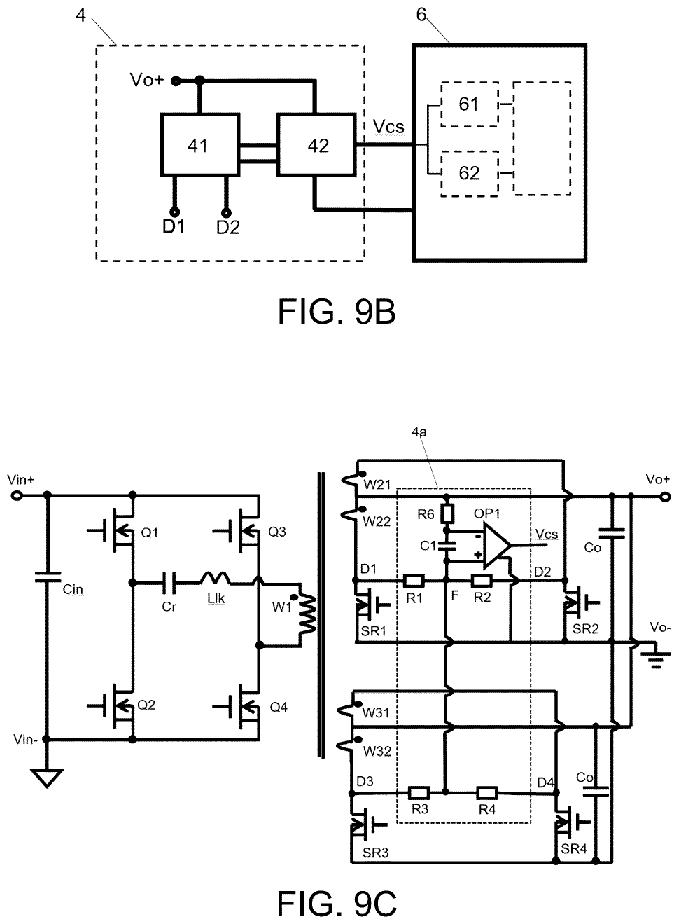

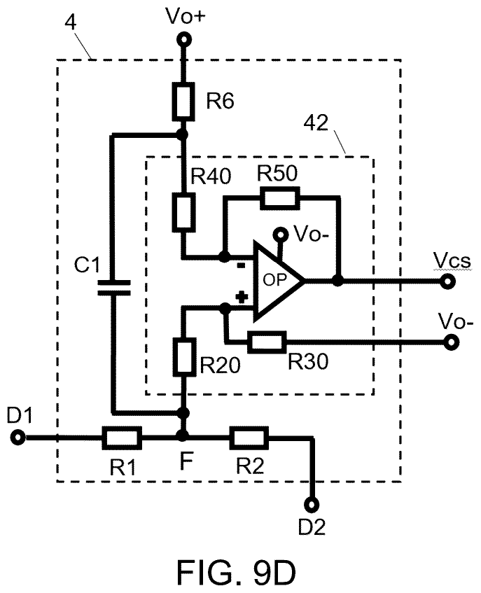

A current sampling circuit, implementation of the current sampling circuit in a power conversion circuit and structure of a corresponding power conversion device are disclosed as follows. The circuit topology of the power conversion device shown in FIG. 9A for example is a full-bridge LLC circuit topology, wherein the magnetic apparatus 3 comprises only one winding group, and the low-voltage circuit 2 comprises only one switching circuit, an output positive terminal and an output negative terminal. A current sampling circuit 4 is further provided. The current sampling circuit 4 comprises a sampling unit 41 and an amplification unit 42, wherein the sampling unit 41 is provided with a sampling input terminal D1, a sampling input terminal D2, a sampling reference terminal and two sampling output terminals; the sampling input terminal D1 and the sampling input terminal D2 are electrically connected with the first ends of the corresponding low-voltage windings respectively, the sampling reference terminal is electrically connected to the output positive terminal Vo+(i.e., a first voltage terminal), and the two sampling output terminals are respectively connected to two input terminals of the amplification unit 42. The sampling unit 41 is configured for sampling the voltages at two ends of the connected low-voltage winding, averaging the voltages and outputting the resulted signals through two sampling output terminals; specifically, the sampling unit 41 comprises a sampling resistor R1, a sampling resistor R2, a sampling capacitor C1 and an impedance-matching resistor R6; and when the influence of the distribution parameter is ignored, the resistance of the sampling resistor R1 is equal to that of the sampling resistor R2, and the resistance of the impedance-matching resistor R6 is equal to the equivalent resistance of the sampling resistors R1 and R2 in parallel; one end of the sampling resistor R1 and one end of the sampling resistor R2 are electrically connected to a middle node F of the bridge arm of the sampling resistors R1 and R2, the other ends of the sampling resistors R1 and R2 are electrically connected to the sampling input terminals D1 and the sampling input terminal D2 respectively; one end of the sampling capacitor C1 is electrically connected to the middle node F, and the other end of the sampling capacitor C1 is electrically connected to the sampling reference terminal through the impedance-matching resistor R6; and the two ends of the sampling capacitor C1 are configured as the two sampling output terminals. The amplification unit 42 comprises an operational amplifier OP1 and is provided with an amplification reference terminal, an amplification input positive terminal, an amplification input negative terminal and an amplification output terminal. The amplification reference terminal is electrically connected with the output negative terminal Vo− (i.e., a second voltage terminal). The amplification input positive terminal is electrically connected with a sampling output terminal of the sampling unit 41, that is, the middle node F, and the amplification input negative terminal is electrically connected with the other sampling output terminal of the sampling unit 41. A current sampling signal Vcs is output through the amplification output terminal of the amplification unit 42, and the current sampling signal Vcs is proportional to the working current of the power conversion device.

In operation of the sampling unit 41, with a reference to the output positive terminal Vo+ of the full-bridge LLC circuit, the voltage VD1 at the drain D1 of the switch SR1 is a sum of the coupling voltage component across the low-voltage winding W22 and the resistance voltage component generated across the parasitic resistance of the low-voltage winding W22 by the current flowing through the switch SR1; similarly, the voltage VD2 between the drain D2 of the switch SR2 and the sampling reference terminal is a sum of the coupling voltage component across the low-voltage winding W21 and the resistance voltage component generated across the parasitic resistance of the low-voltage winding W21 by the current flowing through the switch SR2. The voltage VD1 and the voltage VD2 are averaged and input to the sampling capacitor C1 through the sampling resistors R1 and R2 (two signals are superposed and then the average value is taken). The current flowing through the switch SR1 and the current flowing through the switch SR2 are approximately equal in amplitude and 180 degrees out of phase; the coupling voltage component across the low-voltage winding W22 and the coupling voltage component across the low-voltage winding W21 are equal in magnitude and opposite in direction; the two coupling voltage components are self-counteracted on the sampling capacitor C1, so that the sampling resistor R1 and the sampling capacitor C1 do not need to filter the coupling voltage component across the low-voltage winding W22, the sampling resistor R2 and the sampling capacitor C1 do not need to filter the coupling voltage component across the low-voltage winding W21, and only two parasitic resistance voltage components superposed with a phase offset need to be filtered; the time constant formed by the sampling resistor R1 and the sampling capacitor C1 and the time constant formed by the sampling resistor R2 and the sampling capacitor C1 may be greatly reduced, meeting an alleviated requirement of the filtering effect, Under the condition that the output current of the full-bridge LLC circuit changes dynamically, reduced time constants result in an improved tracking speed of the voltage signal across the sampling capacitor C1 (i.e., the output signal of the sampling unit 41) and the current sampling signal Vcs output by the operational amplifier OP1. The structure of the amplification unit 42 shown in FIGS. 9A-9B is merely an example, and the functions and implementation of the amplification unit disclosed by the present application are not limited thereto, as long as the voltage of the current sampling signal Vcs of the amplification output terminal is proportional to that of the output signal of the sampling unit 41.

On the other hand, the output signal of the sampling unit 41 or the current sampling signal Vcs output by the amplification unit 42 is proportional to the output current of the full-bridge LLC circuit topology with a proportionality coefficient related to the parasitic resistances of the low-voltage winding W22 and the low-voltage winding W21, that is, the proportionality coefficient varies along with the variation of the parasitic resistances of the low-voltage winding W22 and the low-voltage winding W21. In actual production, the value distribution of the parasitic resistance is influenced by the value distribution of the thicknesses and the widths of the low-voltage winding W22 and the low-voltage winding W21, so that the batch-to-batch difference exists. In some embodiments, as shown in FIG. 9B, the current sampling signal Vcs of the current sampling circuit 4 is sent to a control unit 6. The control unit 6 comprises a calibration unit 61, and the current sampling signal Vcs is calibrated, so that the influence of the value distribution of the parasitic resistance of the low-voltage winding W22 and the low-voltage winding W21 on the value distribution of the output signals of the current sampling circuit 4 is cancelled. At another aspect, the parasitic resistance is influenced by the temperature characteristics of the material of the low-voltage winding W22 and the low-voltage winding W21. The control unit 6 further comprises a temperature compensation unit 62, and temperature compensation is carried out on the current sampling signal Vcs sent into the control unit 6, so that the influence of the temperature of the low-voltage winding W22 and the low-voltage winding W21 on the output signals of the current sampling circuit 4 is compensated. In some embodiments, referring to FIG. 9B, the current sampling signal Vcs is sent to the calibration unit 61 and the temperature compensation unit 62 for calibration or temperature compensation respectively, and then the current sampling signal Vcs is sent to other units for functions such as current reporting, closed-loop current control, current-equalization control or over-current protection. In some embodiments, the current sampling signal Vcs is sent to the calibration unit 61 and the temperature compensation unit 62 in sequence for calibration and temperature compensation, and then the current sampling signal Vcs is sent to other units for the aforementioned functions.

In the embodiment shown in FIG. 9A, the current sampling circuit 4 comprises two sampling resistors, the resistors sampling the currents flowing through the two synchronous rectification switches and a superposed-average current obtained. When the current sampling circuit 4 is implemented in the topology shown in FIG. 1A, it may be configured to sample the currents flowing through the switches SR1 and SR2, and the signals are sampled and averaged by superposing for expressing the output current of the overall topology. The sum of current flowing through the switch SR1 and current flowing through the SR2 is half of the output current of the overall topology, but in actual operations of the topology, the sum of current flowing through the switch SR1 and current flowing through the switch SR2 (i.e., the current of the first switching circuit) is not necessarily or always equal to the sum of current flowing through the switch SR3 and current flowing through the switch SR4 (i.e., the current of the second switching circuit), resulting in a problem of data distortion with the configuration of sampling signals merely in the first switching circuit for expressing the output current of the overall topology.

In order to avoid the data distortion, a current sampling circuit 4a is provided as shown in FIG. 9C, sampling and averaging by superposing not only the currents flowing through the switch SR1 and the switch SR2, but also the currents flowing through the switch SR3 and the switch SR4. Compared with the current sampling circuit 4 shown in FIG. 9A, the current sampling circuit 4a further comprises a sampling resistor R3 and a sampling resistor R4, one end of the sampling resistor R3 and one end of the sampling resistor R4 are electrically connected to the middle node F, and the other ends of the sampling resistors R3 and R4 are electrically connected with the drain D3 of the switch SR3 and the drain D4 of the switch SR4 respectively. The resistance of the four sampling resistors R1-R4 are the same, and the resistance of the impedance-matching resistor R6 is equal to the equivalent resistance of the four sampling resistors R1-R4 in parallel. The operating principle of the current detection circuit 4a is similar to the operating principle of the current detection circuit 4. The current sampling circuit 4a takes the output positive terminal Vo+ of the full-bridge LLC circuit topology as a reference, the voltage VD3 between the drain D3 of the switch SR3 and the sampling reference terminal and the voltage VD4 between the drain D4 of the switch SR4 and the sampling reference terminal are superposed and averaged to the sampling capacitor C1. The coupling voltage component across the low-voltage winding W32 and the coupling voltage component across the low-voltage winding W31 are equal in magnitude and opposite in direction. The two coupling voltage components are self-counteracted on the sampling capacitor C1. The current flowing through the switch SR3 and the current flowing through the switch SR4 are approximately equal in amplitude and 180 degrees out of phase. Therefore, the sampling resistor R3 and the sampling capacitor C1 do not need to filter the coupling voltage component across the low-voltage winding W32, the sampling resistor R4 and the sampling capacitor C1 do not need to filter the coupling voltage component across the low-voltage winding W31, and only two parasitic resistance voltage components superposed with a phase offset need to be filtered. Under any condition of operation, the voltage signal across the sampling capacitor C1 as well as the current sampling signal Vcs reflects the total amplitude of the output current of the full-bridge LLC circuit topology.

The current sampling circuits aforementioned may be implemented in Embodiment 1 to Embodiment 7 disclosed by the present application, but are not limited thereto, as long as two low-voltage windings with a switching circuit including two synchronous rectification switches as shown in the above embodiments are provided; the I/O voltages of the voltage terminals (i.e., the input terminals or the output terminals of the power conversion device) electrically connected with the current sampling circuit may be configured as not only direct-current voltages, but also superposed signals of alternating-current voltages and direct-current voltages. The frequency of the alternating-current voltage component is lower than 2000 Hz, and further in some embodiments, the frequency of the alternating-current voltage component is between 50 Hz and 60 Hz.

For further details, the circuit topology of the amplification unit 42 in the current sampling circuit 4 in some embodiments is shown in FIG. 9D, and the amplification unit 42 comprises an operational amplifier OP, a second resistor R20, a third resistor R30, a fourth resistor R40 and a fifth resistor R50; the second resistor R20 is bridged between the positive input terminal of the operational amplifier OP and one end of the sampling capacitor C1, that is, the middle node F; the third resistor R30 is bridged between the positive input terminal of the operational amplifier OP and the reference ground of the operational amplifier OP, which is the output negative terminal Vo− (i.e., the second voltage terminal) of the power conversion device; the resistance of the resistors meet the equation of R30/(R20+(R1∥R2))=R50/(R40+R6), wherein R1∥R2 represents an equivalent resistance of the sampling resistor R1 and the sampling resistor R2 in parallel, other parameters in the equation represent the resistances of the corresponding resistors, and R6 is equal to R1∥R2, as is described above. The structure of the amplification unit is not limited thereto, as long as it provides the function of proportional amplification.

Various embodiments in the present application are described above in a progressive manner, the description of each embodiment mainly focusing on the difference from other embodiments. The same or similar parts between the embodiments may refer to each other for ease of understanding. In general, the embodiments show beneficial effects of a reduced power loss and lowered requirements of capacitance for filtering current ripples, resulting a reduced size of the device. Detailed beneficial effects are indicated with the embodiments.

What is claimed is:

1. A magnetic apparatus, comprising:
a magnetically permeable core and at least two winding groups;
wherein the magnetically permeable core comprises two core plates and five core legs, the five core legs are arranged between the two core plates, the five core legs are respectively a first side core leg, a first winding core leg, a public core leg, a second winding core leg and a second side core leg, and are arranged in the same direction according to the sequence of the first side core leg, the first winding core leg, the public core leg, the second winding core leg and the second side core leg, and a channel between every two adjacent core legs is configured as a winding channel;
wherein the magnetically permeable core are provided with an input side and an output side which are opposite to each other, and the magnetically permeable core are provided with a first winding channel side and a second winding channel side which are opposite to each other; each core plate is provided with four side surfaces corresponding to the input side, the output side, the first winding channel side and the second winding channel side; and the winding channel is configured to penetrate the magnetically permeable core from the first winding channel side to the second winding channel side;
wherein the two winding groups are respectively a first winding group and a third winding group, the first winding group sequentially passes through the two winding channels adjacent to the first winding core leg, and is wound around the first winding core leg for at least one turn; the third winding group sequentially passes through the two winding channels adjacent to the second winding core leg, and is wound around the second winding core leg for at least one turn; and
wherein it is provided in operation that voltage signal across the first winding group and voltage signal across the second winding group have a phase offset of 90 degrees.

2. The magnetic apparatus of claim 1, wherein the voltage signals across each of the two winding groups are configured to have the same shape in waveform.

3. The magnetic apparatus of claim 1, wherein the first winding core leg and the second winding core leg are provided with the same reluctances; and
wherein the first side core leg, the second side core leg and the public core leg are provided with the same reluctances.

4. The magnetic apparatus of claim 3, the reluctance of the first side core leg, the reluctance of the second side core leg and the reluctance of the public core leg are smaller than or equal to the reluctance of the first winding core leg and the second winding core leg.

5. The magnetic apparatus of claim 3, wherein the reluctance of the first side core leg, the reluctance of the second side core leg and the reluctance of the public core leg is smaller than 1/10 of the reluctance of the first winding core leg and the second winding core leg.

6. The magnetic apparatus of claim 1, wherein each winding group comprises two windings; the winding is provided with a first end and a second end; the second end of each winding is electrically connected with each other; the first end of each winding is electrically connected with a switch; the first end of each winding in the first and third winding groups is located on the first winding channel side, and each switch corresponding to the first and third winding groups is arranged close to the first winding channel side.

7. The magnetic apparatus of claim 6, wherein each winding group is wound around the corresponding winding core leg for an odd number of turns, the second end of each winding is located on the second winding channel side, the second end of each winding is electrically connected to at least one output capacitor, and each output capacitor is arranged close to the second winding channel side.

8. The magnetic apparatus of claim 6, wherein each winding group is wound around the winding core leg for an even number of turns, the first end and the second end of each winding are located on the same winding channel side, the second end of each winding is electrically connected with at least one output capacitor, and each output capacitor is arranged close to the first winding channel side.

9. The magnetic apparatus of claim 6, wherein voltage signals across each of the two windings in the same winding group are configured to have a phase offset of 180 degrees, and the voltage signals across each of the four windings are configured to have offsets of 90 degrees progressively in sequence.

10. The magnetic apparatus of claim 6, further comprising a second winding group and a fourth winding group, wherein the second winding group sequentially passes through two winding channels adjacent to the first winding core leg, and is wound around the first winding core leg for at least one turn; the fourth winding group sequentially passes through the two winding channels adjacent to the second winding core leg, and is wound around the second winding core leg for at least one turn; each of the second and fourth winding groups comprises two windings; the second ends of the two windings in the same winding group are electrically connected with each other; the first ends of the two windings are electrically connected with a switch; the first end of each winding in the second and fourth winding groups is located on the second winding channel side; and each switch corresponding to the second and fourth winding groups is arranged close to the second winding channel side.

11. The magnetic apparatus of claim 10, wherein the first end of one winding in the first winding group and the first end of one winding in the second winding group are located in different winding channels, and voltage signals at the two first ends are configured to be same in waveform; the first end of one winding in the third winding group and the first end of one winding in the fourth winding group are located in different winding channels, and voltage signals at the two first ends are configured to be same in waveform; and
wherein the windings in each winding group are low-voltage windings, the magnetic apparatus further comprises two high-voltage windings, and one said high-voltage winding sequentially passes through two winding channels adjacent to the first winding core leg and is wound around the first winding core leg; and the other high-voltage winding sequentially passes through the two winding channels adjacent to the second winding core leg and is wound around the second winding core leg.

12. The magnetic apparatus of claim 6, wherein the windings in each winding group are low-voltage windings, the magnetic apparatus further comprises two high-voltage windings, and one said high-voltage winding sequentially passes through two winding channels adjacent to the first winding core leg and is wound around the first winding core leg; and the other high-voltage winding sequentially passes through the two winding channels adjacent to the second winding core leg and is wound around the second winding core leg.

13. The magnetic apparatus of claim 1, further comprising a first additional winding wound around one side core leg and the winding core leg next to the side core leg as a whole, or further comprising a first additional winding wound around a part of the core plate between the winding core leg and the public core leg; wherein the first additional winding is electrically connected in parallel with one winding corresponding to the winding core leg corresponding thereto; and
wherein the first additional winding is configured for adjusting the AC magnetic flux flowing through the corresponding side core leg to be opposite in direction and half in amplitude compared with the AC magnetic flux flowing through the corresponding winding core leg.

14. The magnetic apparatus of claim 13, further comprising another first additional winding wound around the other side core leg and the other winding core leg as a whole, or further comprising another first additional winding wound around a part of the core plate between the other winding core leg and the public core leg.

15. The magnetic apparatus of claim 1, further comprising a second additional winding;
wherein the second additional winding is wound around the public core leg, two ends of the second additional winding are respectively electrically connected to the first winding group and the second winding group, and the second additional winding is configured for adjusting the AC magnetic flux flowing through the public core leg to be half in amplitude of the superposition of the AC magnetic flux flowing through the two winding core legs.

16. A power module, comprising:
a winding substrate, a magnetically permeable core and output pins;
wherein the winding substrate is provided with a first surface and a second surface opposite to each other,
wherein the magnetically permeable core comprises two core plates and three core legs, the three core legs are arranged between the two core plates, the three core legs are a first side core leg, a winding core leg and a second side core leg respectively, the winding core leg is arranged between the first side core leg and the second side core leg, and a winding channel is provided between each side core leg and the winding core leg;
wherein the magnetically permeable core is provided with an input side and an output side which are opposite to each other, and the magnetically permeable core is provided with a first winding channel side and a second winding channel side which are opposite to each other; each core plate is provided with four side surfaces corresponding to the input side, the output side, the first winding channel side and the second winding channel side; and the winding channel is configured to penetrate the magnetically permeable core from the first winding channel side to the second winding channel side;
wherein the output pins are arranged close to the output side and at least three output pins are provided, at least one of the output pins is configured in a first electrical property and at least one of the output pins is configured in a second electrical property, and the output pins are alternately arranged according to the electrical properties;
wherein the winding substrate is provided with three magnetically-permeable-core holes, and the three magnetically-permeable-core holes match the three core legs in shape; two winding groups is provided in the winding substrate; the two winding groups are a first winding group and a second winding group respectively, and each winding group sequentially passes through the two winding channels and is wound around the winding core leg; and
wherein each winding group comprises two windings, the winding is provided with a first end and a second end, the second ends of the two windings in the same winding group are electrically connected with each other and with at least one of the output pins, and the first ends of the two windings in the first winding group and the first ends of the two windings in the second winding group are arranged opposite on the first winding channel side and the second winding channel side respectively.

17. The power module of claim 16, wherein the output pins are arranged in an array along the side surface corresponding to the output side.

18. The power module of claim 16, wherein each winding group is wound around the corresponding winding core leg for an odd number of turns, and the second end and the first end of each winding in each winding group are respectively arranged on the first winding channel side and the second winding channel side.

19. The power module of claim 16, wherein each winding group is wound around the corresponding winding core leg for an even number of turns, and the second end and the first end of each winding in each winding group are arranged on the same winding channel side.

20. The power module of claim 16, further comprising at least one first switching circuit and at least one second switching circuit, wherein the first switching circuit and the second switching circuit are respectively arranged on the first winding channel side and the second winding channel side and close to openings of the winding channels; each of the first and second switching groups comprises two switches; one ends of the two switches in the same switching circuit are electrically connected with the first ends of the two windings in the same winding group respectively, the other ends of the two switches are electrically connected with each other and are electrically connected with the output negative pins, and the second ends of the windings are electrically connected with the output positive pins.

21. The power module of claim 20, wherein control signals are provided for the switches; the control signals of the two switches in the same switching circuit are in a phase offset of 180 degrees, one switch in the first switching circuit and one switch in the second switching circuit are arranged close to different winding channels, and the control signals of the two switches are same.

22. The power module of claim 20, wherein two first switching circuits and two second switching circuits are provided; the two first switching circuits are arranged on the first surface and the second surface of the winding substrate respectively; the two first switching circuits partially overlap or wholly coincide with each other in projection to the first surface, and the two first switching circuits are electrically connected in parallel by vias through the winding substrate; the two second switching circuits are arranged on the first surface and the second surface of the winding substrate respectively; the two second switching circuits partially overlap or wholly coincide with each other in projection to the first surface, and the two second switching circuits are electrically connected in parallel by vias through the winding substrate.

23. The power module of claim 20, further comprising at least one output capacitor, wherein the output capacitor is bridged between the second end of the winding and the corresponding other end of the switch connected with the first end of the winding.

24. The power module of claim 23, wherein at least one output capacitor is arranged on the outer side of the magnetically permeable core on the first winding channel side, and at least one output capacitor is arranged on the outer side of the magnetically permeable core on the second winding channel side.

25. The power module of claim 23, wherein at least one output capacitor is arranged on the outer side of the first switching circuit, and at least one output capacitor is arranged on the outer side of the second switching circuit.

26. The power module of claim 16, further comprising a high-voltage winding, wherein the windings in the winding groups are low-voltage windings, and the high-voltage winding sequentially passes through the two winding channels and is wound around the winding core leg for at least one turn; and two ends of the high-voltage winding are arranged on the same winding channel side.

27. The power module of claim 17, wherein included angle between the arrangement direction of the array and the side surface is less than or equal to 45 degrees.

28. A power conversion device, comprising:
a winding substrate, a magnetic apparatus, a first switching circuit, a second switching circuit, a first output capacitor group, a second output capacitor group, a first output pin group and a second output pin group;
wherein the winding substrate is provided with a first surface and a second surface which are opposite to each other; the second surface is provided with a first output region, a first switch region, a magnetic assembly region, a second switch region and a second output region; the first output region, the first switch region, the magnetic assembly region, the second switch region and the second output region are sequentially arranged in the same direction; and
wherein the magnetic apparatus is assembled in the magnetic assembly region; the first switching circuit is arranged in the first switch region; the second switching circuit is arranged in the second switch region; at least one part of the first output capacitor group and/or at least one part of the first output pin group is arranged in the first output region; at least one part of the second output capacitor group and/or at least one part of the second output pin group is arranged in the second output region.

29. The power conversion device of claim 28, wherein the first output capacitor group, the first switching circuit, the magnetic apparatus, the second switching circuit and the second output capacitor group are sequentially arranged in the same direction.

30. The power conversion device of claim 28, wherein the first output pin group, the first switching circuit, the magnetic apparatus, the second switching circuit and the second output pin group are sequentially arranged in the same direction.

31. The power conversion device of claim 28, wherein the first output pin group, the first output capacitor group, the first switching circuit, the magnetic apparatus, the second switching circuit, the second output capacitor group and the second output pin group are sequentially arranged in the same direction.

32. The power conversion device of claim 28, wherein the magnetic apparatus comprises a magnetically permeable core; the magnetically permeable core comprises two core plates and at least three core legs; the core legs are arranged between the two core plates; the core legs comprise a first side core leg, a second side core leg and at least one winding core leg; the winding core leg is arranged between the first side core leg and the second side core leg, and winding channels are provided between the winding core leg and the adjacent core legs; the magnetically permeable core is provided with a first winding channel side and a second winding channel side which are opposite to each other; the winding channel is configured to penetrate the magnetic permeable core from the first winding channel side to the second winding channel side.

33. The power conversion device of claim 32, wherein the winding substrate is provided with at least three magnetically-permeable-core holes; the magnetically-permeable-core holes match the at least three core legs in number and shape; two winding groups are provided in the winding substrate; the two winding groups are a first winding group and a second winding group respectively, and each winding group sequentially passes through two winding channels adjacent to the winding core leg and is wound around the corresponding winding core leg; each winding group comprises two windings; each winding is provided with a first end and a second end; the second ends of the two windings in the same winding group are electrically connected; the first ends of the two windings in the first winding group and the first ends of the two windings in the second winding group are arranged on the first winding channel side and the second winding channel side respectively; and
wherein the first switch region is located on the first winding channel side, and the second switch region is located on the second switch region.

34. A DC-DC conversion device, comprising:
high-voltage terminals and low-voltage terminals, wherein the DC-DC conversion device is used for voltage transformation between the high-voltage terminal and the low-voltage terminal, and the ratio of voltage at the high-voltage terminal to voltage at the low-voltage terminal is K;
at least one high-voltage capacitor, at least one low-voltage capacitor and N circuit units, wherein N is an integer greater than or equal to 2, and each circuit unit comprises a high-voltage circuit and a low-voltage circuit;
wherein the circuit unit further comprises a transformer; the transformer is electrically connected with the low-voltage circuit and is electrically connected to at least one low-voltage capacitor;
wherein the high-voltage circuit comprises two bridge arms; the two bridge arms are respectively a first bridge arm and a second bridge arm; the first bridge arm comprises an upper switch and a lower switch which are electrically connected in series; at least one part of the transformer is configured for forming at least one resonance branch; one end of the resonance branch is electrically connected with the first bridge arm, and the other end of the resonance branch is electrically connected with the second bridge arm;
wherein the DC-DC conversion device is provided with N control signal groups, the N control signal groups respectively control the switches in the N circuit units, each control signal group comprises a first control signal; the duty ratio of the first control signal in each control signal group is identical, and first control signals in the N control signal groups are configured to have a phase offset of 360/(2N) degrees progressively in sequence;
wherein resonant capacitors are provided in the high-voltage circuits; equivalent total capacitance of the low-voltage capacitors in a steady state operation is less than or equal to N×K×K times the equivalent total capacitance of the resonant capacitors.

35. The DC-DC conversion device of claim 34, wherein the equivalent total capacitance of the low-voltage capacitor in a steady state operation is less than or equal to 0.5×N×K×K times the equivalent total capacitance of the resonant capacitors.

36. The DC-DC conversion device of claim 34, wherein the equivalent total capacitance of the low-voltage capacitor in a steady state operation is less than or equal to 0.25×N×K×K times the equivalent total capacitance of the resonant capacitors.

37. The DC-DC conversion device of claim 34, wherein the equivalent total capacitance of the high-voltage capacitor in a steady state operation is less than or equal to N times the equivalent total capacitance of the resonant capacitors.

38. The DC-DC conversion device of claim 34, wherein the equivalent total capacitance of the high-voltage capacitor in a steady state operation is less than or equal to 0.25×N times the equivalent total capacitance of the resonant capacitors.

39. The DC-DC conversion device of claim 34, wherein each high-voltage circuit in the N circuit units is connected in parallel and then bridged between two ends of the at least one high-voltage capacitor, and each low-voltage circuit in the N circuit units is connected in parallel and then bridged between the two ends of the at least one low-voltage capacitor; and
wherein negative terminal of the at least one high-voltage capacitor is electrically connected with negative terminal of the at least one low-voltage capacitor, or negative terminal of the at least one high-voltage capacitor is electrically isolated from negative terminal of the at least one low-voltage capacitor.

40. The DC-DC conversion device of claim 34, wherein the low-voltage circuits are electrically connected in parallel; each of the low-voltage circuits is bridged between two ends of at least one low-voltage capacitor; the high-voltage circuits are electrically connected in parallel; one end of each of the high-voltage circuits is electrically connected with a positive terminal of at least one high-voltage capacitor; the other end of each of the high-voltage circuits is electrically connected with a negative terminal of at least one low-voltage capacitor; and a negative terminal of at least one high-voltage capacitor is electrically connected with a positive terminal of at least one low-voltage capacitor.

41. The DC-DC conversion device of claim 34, wherein the transformer comprises at least one winding group; each winding group comprises two low-voltage windings; second ends of the two low-voltage windings are electrically connected with each other and with at least one output capacitor; first ends of the two low-voltage windings are electrically connected with the low-voltage circuit respectively.

42. The DC-DC conversion device of claim 41, wherein the transformer comprises at least one high-voltage winding;
wherein at least one additional inductor is provided in the high-voltage circuit for an equivalent resonant inductor, or leakage inductance of the at least one high-voltage winding forms an equivalent resonant inductor; and
wherein the resonant capacitor, the equivalent resonant inductor and the high-voltage winding are electrically connected in series in the resonance branch.

43. The DC-DC conversion device of claim 42, wherein the second bridge arm comprises an upper switch and a lower switch which are electrically connected in series; ends of the two bridge arms corresponding to the upper switch are electrically connected; the two ends of the resonance branch are electrically connected with middle nodes of the two bridge arms respectively; each control signal group further comprises a second control signal; the first control signal and the second control signal are configured to have a phase offset of 180 degrees; the upper switch of the first bridge arm and the lower switch of the second bridge arm are controlled by the first control signal, and the lower switch of the first bridge arm and the upper switch of the second bridge arm are controlled by the second control signal.

44. The DC-DC conversion device of claim 41, wherein the transformer comprises at least one high-voltage winding;
wherein at least one additional inductor is provided for an equivalent resonant inductor, or leakage inductance of the at least one high-voltage winding forms an equivalent resonant inductor;
wherein the equivalent resonant inductor and the part of the transformer are electrically connected in series in the resonance branch; and
wherein the resonant capacitors are configured as the second bridge arm; each second bridge arm comprises two resonant capacitors which are electrically connected in series, the first bridge arm is electrically connected with the second bridge arm in parallel; the two ends of the resonance branch are electrically connected with middle nodes of the first bridge arm and the second bridge arm respectively.

45. The DC-DC conversion device of claim 43, wherein the high-voltage circuit is connected in parallel with at least one high-voltage capacitor.

46. The DC-DC conversion device of claim 43, wherein one end of the high-voltage circuit is electrically connected with a positive terminal of the at least one high-voltage capacitor; the other end of the high-voltage circuit is electrically connected with a negative terminal of the at least one low-voltage capacitor; a negative terminal of the at least one high-voltage capacitor is electrically connected with a positive terminal or the negative terminal of the at least one low-voltage capacitor.

47. The DC-DC conversion device of claim 42, wherein the second bridge arm comprises an upper switch and a lower switch which are electrically connected in series, and ends of the two bridge arms corresponding to the upper switch are electrically connected; the low-voltage circuit comprises two low-voltage switches, one ends of the two low-voltage switches are electrically connected, and the other ends of the two low-voltage switches are electrically connected with the other ends of the two bridge arms respectively; each control signal group further comprises a second control signal, and the first control signal and the second control signal are configured to have a phase offset of 180 degrees;
wherein the first control signal controls the upper switch of the first bridge arm, the lower switch of the second bridge arm and the low-voltage switch corresponding to the first bridge arm; and
wherein the second control signal controls the upper switch of the second bridge arm, the lower switch of the first bridge arm and the low-voltage switch corresponding to the second bridge arm.

48. The DC-DC conversion device of claim 47, wherein the resonance branch is bridged between the middle nodes of the two bridge arms.

49. The DC-DC conversion device of claim 47, wherein two high-voltage windings are provided, and two resonance branches are provided corresponding to the two bridge arms; and
wherein one end of each resonance branch is electrically connected with middle node of one corresponding bridge arm, and the other end of each resonance branch is electrically connected with the electrical connection node of the other bridge arm and the low-voltage circuit.

50. The DC-DC conversion device of claim 42, wherein the second bridge arm comprises an upper switch and a lower switch which are electrically connected in series, one ends of the two bridge arms are electrically connected; the low-voltage circuit comprises two low-voltage switches; one ends of the two low-voltage switches are electrically connected; the other ends of the two low-voltage switches are electrically connected with the other ends of the two switch bridge arms respectively; each control signal group further comprises a second control signal, and the first control signal and the second control signal are configured to have a phase offset of 180 degrees;
wherein the first control signal controls an upper switch of one bridge arm, a low-voltage switch electrically connected with the corresponding bridge arm and a lower switch of the other bridge arm; and the second control signal controls a lower switch of the corresponding bridge arm, an upper switch of the other bridge arm and a low-voltage switch electrically connected with the other bridge arm; and
wherein at least two equivalent resonant inductors are provided, the two equivalent resonant inductors are respectively electrically connected with a resonant capacitor for forming two resonance branches corresponding to the two bridge arms; one end of each resonance branch is electrically connected with the middle node of one corresponding bridge arm, and the other end of each resonant branch is electrically connected with electrical connection node of the other bridge arm and the low-voltage circuit.

51. The DC-DC conversion device of claim 34, wherein two resonant capacitors are provided for forming the second bridge arm; the two resonant capacitors are electrically connected in series in the second bridge arm; the second bridge arm is electrically connected with the first bridge arm in parallel; the transformer comprises at least one high-voltage winding and at least two low-voltage windings; at least one equivalent resonant inductor is provided; the at least one high-voltage winding is electrically connected with the equivalent resonant inductor for forming a resonance branch; one end of the resonance branch is electrically connected with a middle node of the first bridge arm, and the other end of the resonance branch is electrically connected with a middle node of the second bridge arm; second ends of the two low-voltage windings are electrically connected with each other and with the at least one output capacitor; first ends of the two low-voltage windings are electrically connected with the low-voltage circuit respectively.

52. The DC-DC conversion device of claim 34, wherein the transformer comprises a magnetic apparatus, wherein the magnetic apparatus comprises:
a magnetically permeable core and at least two winding groups;
wherein the magnetically permeable core comprises two core plates and five core legs, the five core legs are arranged between the two core plates, the five core legs are respectively a first side core leg, a first winding core leg, a public core leg, a second winding core leg and a second side core leg, and are arranged in the same direction according to the sequence of the first side core leg, the first winding core leg, the public core leg, the second winding core leg and the second side core leg, and a channel between every two adjacent core legs is configured as a winding channel;
wherein the magnetically permeable core are provided with an input side and an output side which are opposite to each other, and the magnetically permeable core are provided with a first winding channel side and a second winding channel side which are opposite to each other; each core plate is provided with four side surfaces corresponding to the input side, the output side, the first winding channel side and the second winding channel side; and the winding channel is configured to penetrate the magnetically permeable core from the first winding channel side to the second winding channel side;
wherein the two winding groups are respectively a first winding group and a third winding group, the first winding group sequentially passes through the two winding channels adjacent to the first winding core leg, and is wound around the first winding core leg for at least one turn; the third winding group sequentially passes through the two winding channels adjacent to the second winding core leg, and is wound around the second winding core leg for at least one turn; and
wherein it is provided in operation that voltage signal across the first winding group and voltage signal across the second winding group have a phase offset of 90 degrees.
